(19) United States
(12) Patent Application Publication
(10) Pub. No.: US 2017/0330481 A1
(43) Pub. Date: Nov. 16, 2017

(54) INTERACTIVE CULINARY GAME APPLICATIONS

(71) Applicant: Chef Koochooloo, Inc., Mountain View, CA (US)

(72) Inventor: Layla Sabourian-Tarwe, Mountain View, CA (US)

(21) Appl. No.: 15/665,151

(22) Filed: Jul. 31, 2017

Related U.S. Application Data
(63) Continuation-in-part of application No. 14/690,137, filed on Apr. 17, 2015, now Pat. No. 9,728,098.
(60) Provisional application No. 61/981,540, filed on Apr. 18, 2014.

(51) Int. Cl. G09B 19/00; A63F 13/80; G09B 5/06

(52) U.S. Cl. CPC G09B 19/0092; G09B 5/06; A63F 13/80; A63F 2300/8094

(57) ABSTRACT

A culinary application enables consumers, such as a parent and a child, to engage in discovering cooking recipes in a fun interactive way while also learning about various topics, including math, science, geography and social responsibility. The culinary application can be focused towards children of various age groups. Consumers engage with the culinary game application in an interactive way to search for recipes based on various user preferences such as a favorite ingredient, a diet, a cooking duration, an ethnic group, a particular country, etc. The culinary application can also present trivia related to a recipe, such as benefits of a particular ingredient in the recipe, information about a country where a dish is popular, math involved in measurements of ingredients, etc. The culinary application can generate separate sets of instructions for a parent and child.

### CROSS-REFERENCE TO RELATED APPLICATION(S)

This application is a continuation-in-part of U.S. application Ser. No. 14/690,137 titled “INTERACTIVE CULINARY GAME APPLICATIONS” filed Apr. 17, 2015, which claims the benefit of U.S. Provisional Application Ser. No. 61/981,540 titled “INTERACTIVE CULINARY GAME APPLICATIONS” filed Apr. 18, 2014, all of which are incorporated herein by reference for all purposes in their entirety.

### BACKGROUND

While innovations arise in many areas of everyday life, little has changed with regards to recipes and culinary instructions. Current tools for recipe delivery are typically naïve; they present recipes generally in a flat approach that provides bare-bone publications of information (e.g., printed materials, instructional videos, static webpages, or semantic searches), lacking in experience to properly meet the realities of day-to-day cooking faced by the ordinary consumer. Further, delivery of the recipes through these publications provide no insights to the cooking experience, such as food knowledge, nutrition, wellness education, meal planning, a better execution of cooking at home, or how to save money on meals. Some online cooking applications present recipes to the users based on various user preferences. However, these cooking applications are generally targeted to users of adult age range. These cooking applications are typically not child-friendly. The cooking applications offer minimum to none insight to children who are interested in cooking, or to parents who want to engage their children in cooking. Some of the cooking applications have user interfaces that are less-intuitive, complex and not user friendly, which can typically discourage a user from using the cooking application. Further, some of these cooking applications also lack educational features, that is, they fail to provide any educational information to the children.

### BRIEF DESCRIPTION OF THE DRAWINGS

FIG. 1 is a block diagram illustrating an environment in which a culinary application can be implemented.

FIGS. 2A, 2B and 2C, collectively referred to as FIG. 2, is an example template of a recipe and trivia that can be generated using the culinary application of FIG. 1, consistent with various embodiments.

FIG. 3A is an example graphical user interface (GUI) using which a user can specify a country of the dish the user is interested in, consistent with various embodiments.

FIG. 3B is another example GUI using which a user can specify a country of the dish the user is interested in, consistent with various embodiments.

FIGS. 4A and 4B are examples of GUIs for displaying trivia related to the country selected in the GUI of FIG. 3, consistent with various embodiments.

FIG. 5A is an example GUI for displaying a list of dishes of the country selected in FIG. 3, consistent with various embodiments.

FIG. 5B is an example GUI for specifying a list of ingredients, consistent with various embodiments.

FIG. 6 is an example GUI for displaying a user selected dish and ingredients of the dish, consistent with various embodiments.

FIG. 7 is an example GUI for displaying information associated with an ingredient of a dish, consistent with various embodiments.

FIG. 8 is an example GUI for displaying trivia related to the selected dish, consistent with various embodiments.

FIG. 9 is an example GUI for displaying a first set of instructions of the recipe, which includes information regarding activities to be performed by a big chef, consistent with various embodiments.

FIG. 10 is an example GUI for displaying a second set of instructions of the recipe, which includes information regarding activities to be performed by a little chef under the supervision of the big chef.

FIG. 11 is an example of a GUI for displaying trivia related to the recipe of a user selected dish, consistent with various embodiments.

FIG. 12 is an example of a GUI for disp 20-22, laying presentation instructions of the dish, consistent with various embodiments.

FIG. 13 is an example list of features of the culinary application of FIG. 1, consistent with various embodiments.

FIG. 14 is a block diagram of the server of FIG. 1, consistent with various embodiments.

FIG. 15 is a flow diagram of a process for discovering recipes using a culinary application of FIG. 1, consistent with various embodiments.

FIG. 16 is a block diagram of an environment in which the culinary application of FIG. 1 can be implemented consistent with various embodiments.

FIG. 17 is a flow diagram for generating a recipe recommendation to improve an emotional state of a user, consistent with various embodiments.

FIG. 18 is a flow diagram for generating a recipe recommendation that is customized for a user, consistent with various embodiments.

FIG. 19 is a block diagram of a computer system as may be used to implement features of some embodiments of the disclosed technology.

### DETAILED DESCRIPTION

Introduced here is a technology for providing an interactive culinary experience (“the technology”). The technology includes a culinary game application (“culinary application”) that enables consumers, such as a parent and a child, to engage in discovering cooking recipes in an interactive way and that is interesting to the child while also learning about various topics, including math, science, geography and social responsibility. The culinary application can be configured for children of various age groups. For example, the recipes, the look and feel of a graphical user interface (GUI) of the culinary application, e.g., images, videos, icons, can be configured in a way that is appropriate or attractive to a specified age group. The users engage with the culinary application in an interactive way to search for recipes based on various user preferences such as a favorite ingredient, vegetable, fruit of the consumer, a type of occasion, a cooking duration, a type of ingredient, a type of diet, equipment that may be required, an ethnic group, a particular culture, a particular country, etc.

After a dish is selected, the culinary application generates the recipe for the dish. The recipe can include two sets of instructions for preparing the selected dish. For example, a first set of instructions can include information regarding the activities to be performed by a first user of a specified age range, e.g., a parent, to prepare the dish and a second set of instructions can include information regarding the activities to be performed by a second user, e.g., a child, in preparing the dish. In some embodiments, the second set of instructions can include instructions for guiding the parent on how to safely involve the child in the cooking process. The first set of instructions and the second set of instructions can be mutually exclusive, e.g., different or distinct. In some embodiments, by generating two different sets of instructions and having different activities for both the parent and child and by facilitating the parent to guide the child in the cooking process, the culinary application enables the parent and the child to engage with each other.

In the discovery process of the recipes, the culinary application can also present certain trivia related to the recipe. The trivia can be in various subjects, e.g., math, science, geography, social awareness. The trivia can include information such as benefits of a particular ingredient in the recipe, information about a country where a dish prepared using the recipe is popular, math involved in measurements of ingredients, awareness about social causes in the particular country, etc. In some embodiments, the trivia can be presented in a format that is interesting to the child, e.g., as a quiz, an image, a video, animation. In some embodiments, the recipe is presented after the child has viewed at least some of the trivia. For example, the culinary application can display the recipe only after the child answers a quiz. In some embodiments, ensuring that the recipe is generated after the user has answered a quiz facilitates in ensuring that the child is also learning about various topics while learning cooking. The trivia can be presented at various stages, e.g., while the child is selecting the parameters for discovering the recipes and after the recipe is generated.

Further, the culinary application can generate recipe recommendations based on an emotional data associated with the user. For example, if the emotional data indicates that the user is depressed, the culinary application can recommend a recipe containing an ingredient, such as saffron, that is known to be an antidepressant. The dish prepared based on the recommend recipe can improve the emotional condition of the user. In another example, if the emotional data indicates that the user is stressed, the culinary application can recommend a recipe containing an ingredient, such as dark chocolates, blue berries or almonds, that is known to beat the stress. The dish prepared based on the recommended recipe can improve the emotional condition of the user.

The emotional data associated with the user can be collected using various means, e.g., a wearable device associated with the user, by capturing an image of a face of the user and analyzing the image, and/or eliciting responses for questions targeted to collection data indicative of an emotional state of the user. In some embodiments, the culinary application can elicit feedback from the user regarding whether the dish prepared based on the recommended recipe improved the emotional condition, and can use the feedback in improving the recipe recommendations to the user or other users with a similar emotional state.

The culinary application can generate recipe recommendations that are customized/personalized for a user. For example, the culinary application can analyze various data such as historical data, which indicates recipes selected by the user in the past, recipe selection parameters input by the user, a frequency with which a particular recipe selection parameter is selected, a category of recipes selected, ratings or scores assigned to the recipes, recipes selected by other users having a profile similar to that of the user to determine a recipe selection pattern of the user, user engagement data indicative of user engagement with the culinary application, demographic data of the users, and/or behavioral data of the users. The culinary application can then generate the recipe recommendations based on the recipe selection pattern. In some embodiments, the culinary application can employ artificial intelligence or machine learning techniques in determining the recipe selection pattern and/or generating the recipe recommendations.

The culinary application can also present trivia associated with the recipe based on the recipe selection pattern. In some embodiments, the trivia can be selected from various data sources, e.g., a third party data source that includes content defined based on a specified curriculum, such as Nutrition Science and Human Geography, for users of a certain age range, and other sources, which provides facts or other contents associated with a recipe, ingredient, trivia related to the recipe, ingredient or cooking in general. The culinary application can also be another source of trivia, as it can store various trivia received from various entities, e.g., cooking experts, nutritionists, etc. The culinary application can employ a mind-mapping function, which allows users to associate separate contents from various data sources which can subsequently be used by the culinary application to be presented to the user along with a recipe.

### Environment

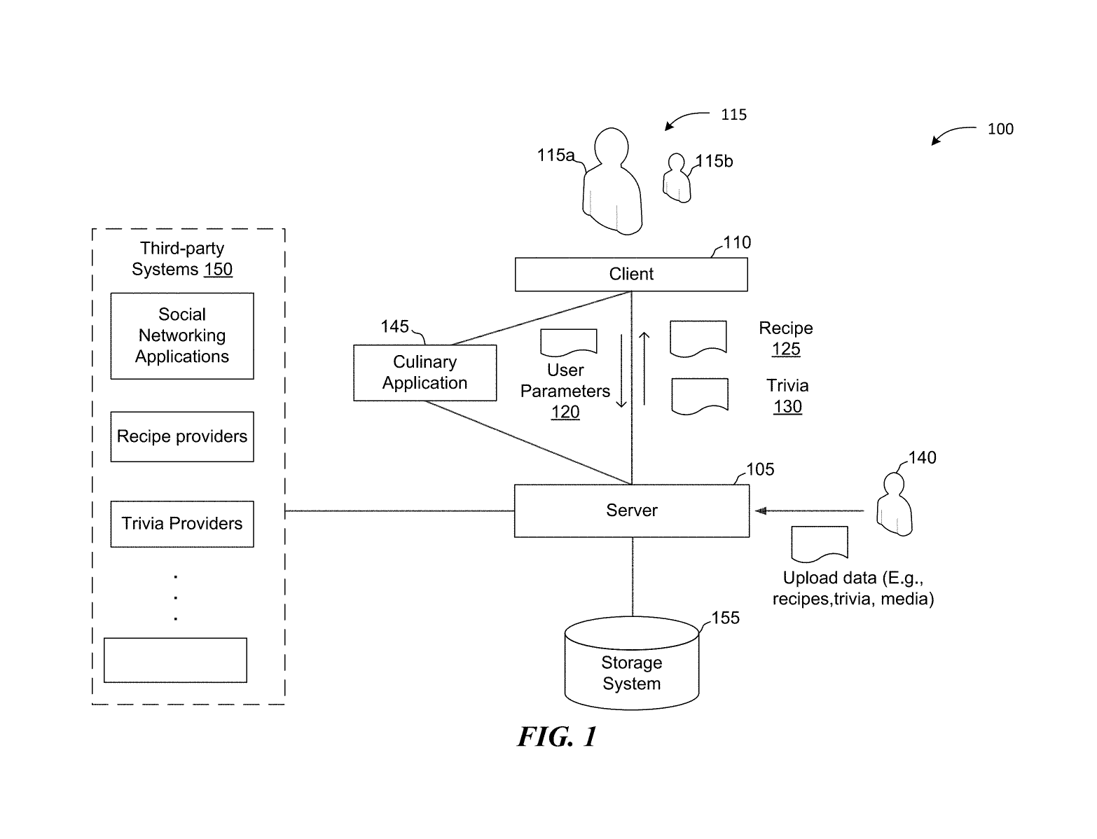

FIG. 1 is a block diagram illustrating an environment 100 in which a culinary application can be implemented. The environment 100 includes a server computing device (“server”) 105 that can be used to implement a culinary application 145 using which consumers can search for recipes. The terms “user” and “consumer” which refers to a user using the culinary game application can be used interchangeably. Note that the terms “big chef” and “little chef” as used herein refer to users of different age groups. For example, a big chef can refer to a user of an adult age group, e.g., 13 years and above, who can safely guide the “little chef” in the cooking process, and a little chef can refer to a user of a little chef age group, e.g., 4-12 years, who can perform the activities in the cooking process under the guidance of the big chef. In one example, a big chef can be a parent and a little chef can be a child of the parent. Further, note that unless specified otherwise the user 115 can refer to a big chef 115a and/or a little chef 115b.

The culinary application 145 can facilitate children to search for recipes, learn various aspects while searching recipes, and indulge in preparing a meal with their parents using the generated recipe. The culinary application 145 can be implemented in various formats. For example, the culinary application 145 can be implemented as an online website, e.g., executing on the server 105, that can be accessed using a browser application on a client computing device (“client”) 110. In another example, the culinary application 145 can be implemented as a downloadable application (“app”) that can be downloaded to and installed on the client 110. In some embodiments, a portion of the culinary application 145 can be implemented on the server 105 and another portion on the client 110. The client 110 can includes various devices such as a tablet, a laptop, a smartphone, a desktop, or any other computing device that is capable of accessing the culinary application 145.

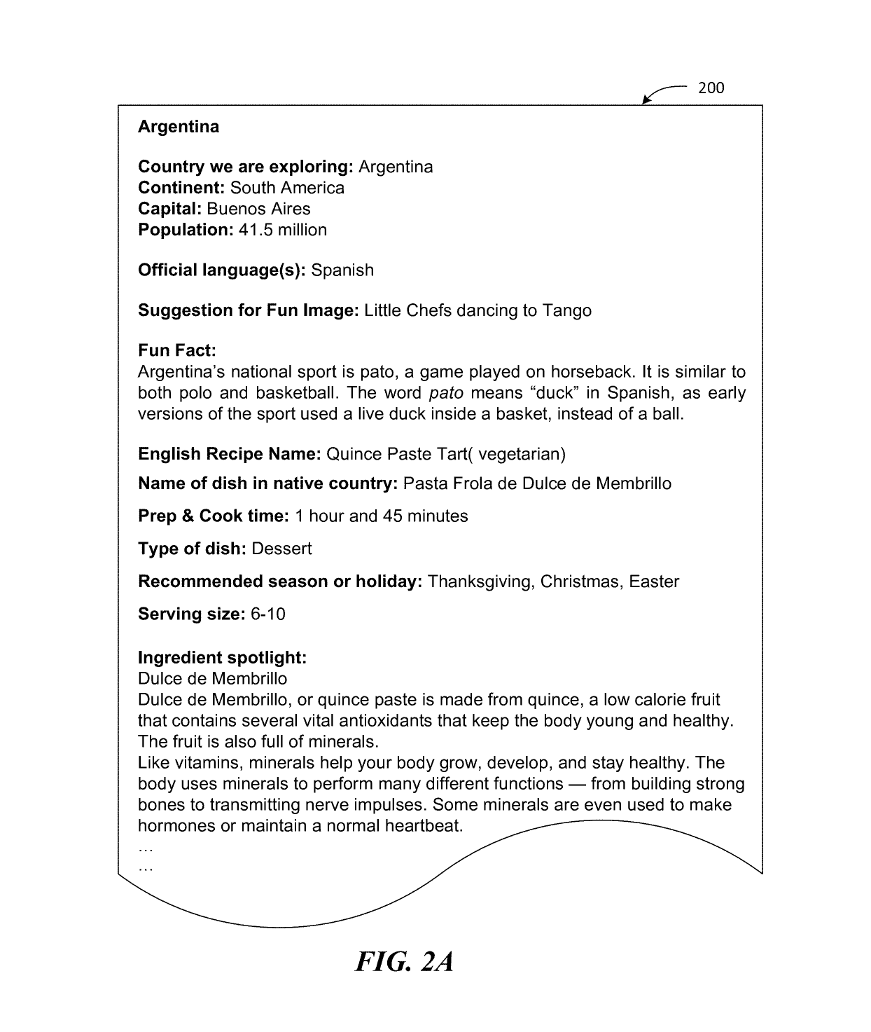

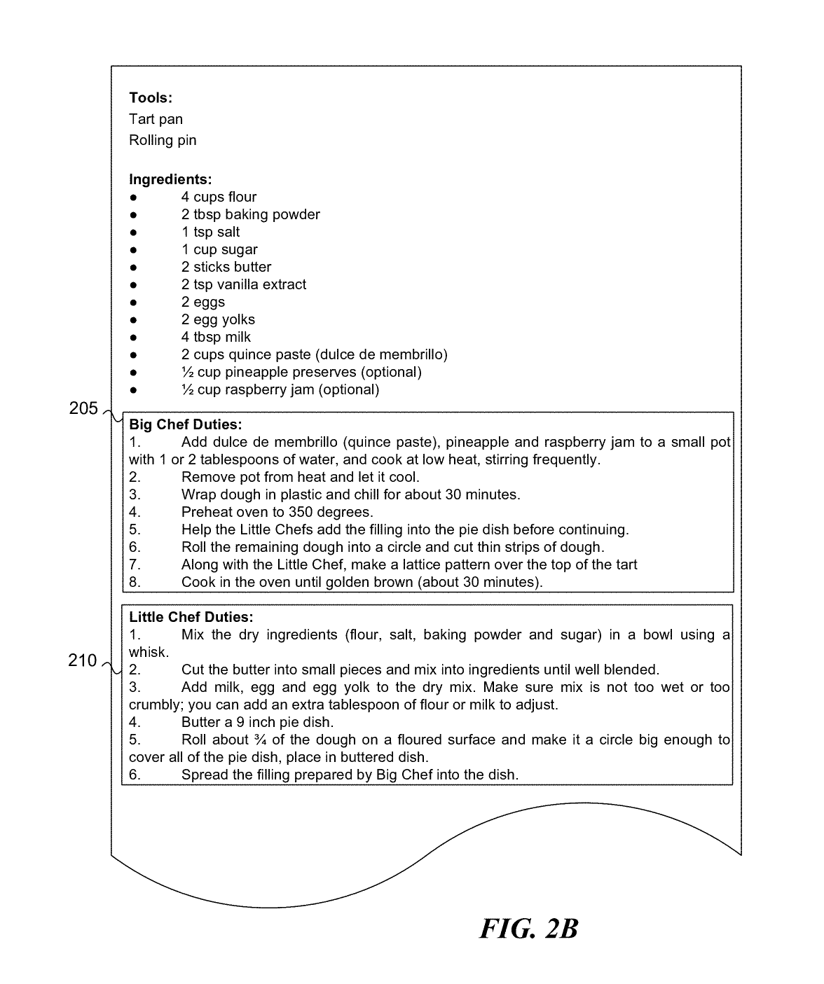

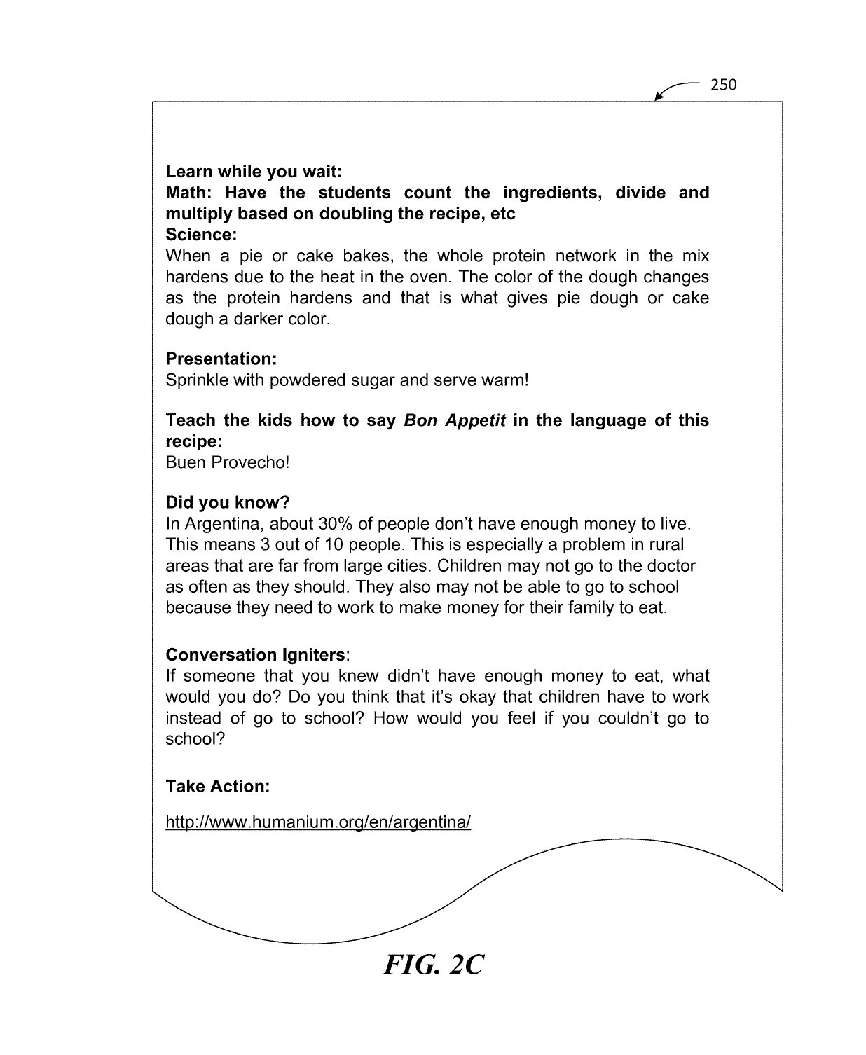

The server 105 can obtain information, including recipes, trivia, user profile information of the user from various sources, e.g., third party systems 150. The server 105 can obtain recipes from third party systems 150, e.g., of third parties that have partnered with an entity associated with the culinary application 145 and/or from users of the culinary application 145. The server 105 can also share recipes with the third party systems 150. The server 105 can facilitate the users to share their recipes with other users of the culinary application 145 and/or users in a social networking application. The server 105 can interact with the third party systems 150 to obtain trivia, e.g., trivia related to a recipe. The server 105 can also provide an application programming interface (API) using which a third party can integrate the culinary application 145 with their application. For example, using the API, a third party culinary website can display some of the recipes associated with the culinary application 145 to their users. The server 105 can also facilitate a social networking application to integrate the culinary application 145 using the API. The server 105 can interact with the third party systems 150, such as charitable organizations, to contribute to a social cause, e.g., to donate money to a charitable organization. The server 105 can store information, e.g., recipes, trivia, user profile information of the user at a storage system 155. In some embodiments, the recipes and/or the trivia can also be uploaded to the server 105 by a user associated with the server 105, e.g., an administrator 140 of the server 105. In some embodiments, the server 105 stores the recipe and the trivia in a specific format, e.g., as a recipe template (which is described at least with reference to FIGS. 2A-2C below).

The server 105 enables the user 115 to search for recipes in an interactive way while learning about various other topics, including math, science, geography and social responsibility. For example, the server 105 generates not only a recipe 125, but also presents trivia 130 that can include information on various topics, e.g., nutritional information, information about places, information about culture where the recipe is popular, math involved in measurements.

The user 115 can specify a set of parameters 120 based on which the server 105 can search for recipes. For example, the set of parameters 120 can include a country whose dishes the user 115 is interested in, ingredients of the dish the user 115 is interested in, a calories range of the dishes the user 115 is interested in, nutritional information, a favorite vegetable and/or fruit, a type of occasion, a cooking duration, a type of ingredient, a type of diet, equipment that may be required, an ethnic group, a particular culture. The user 115 can also select a particular dish the user is interested in. In some embodiments, the server 105 generates a GUI on the client 110 using which the user 115 can interact with the culinary application 145.

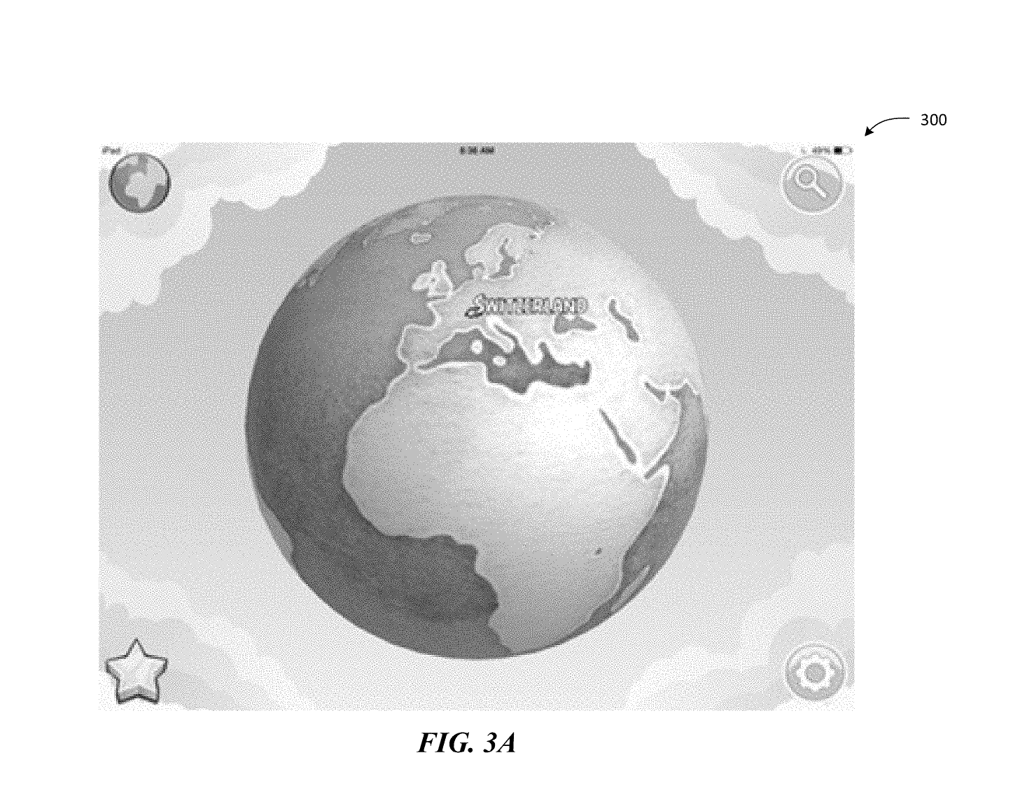

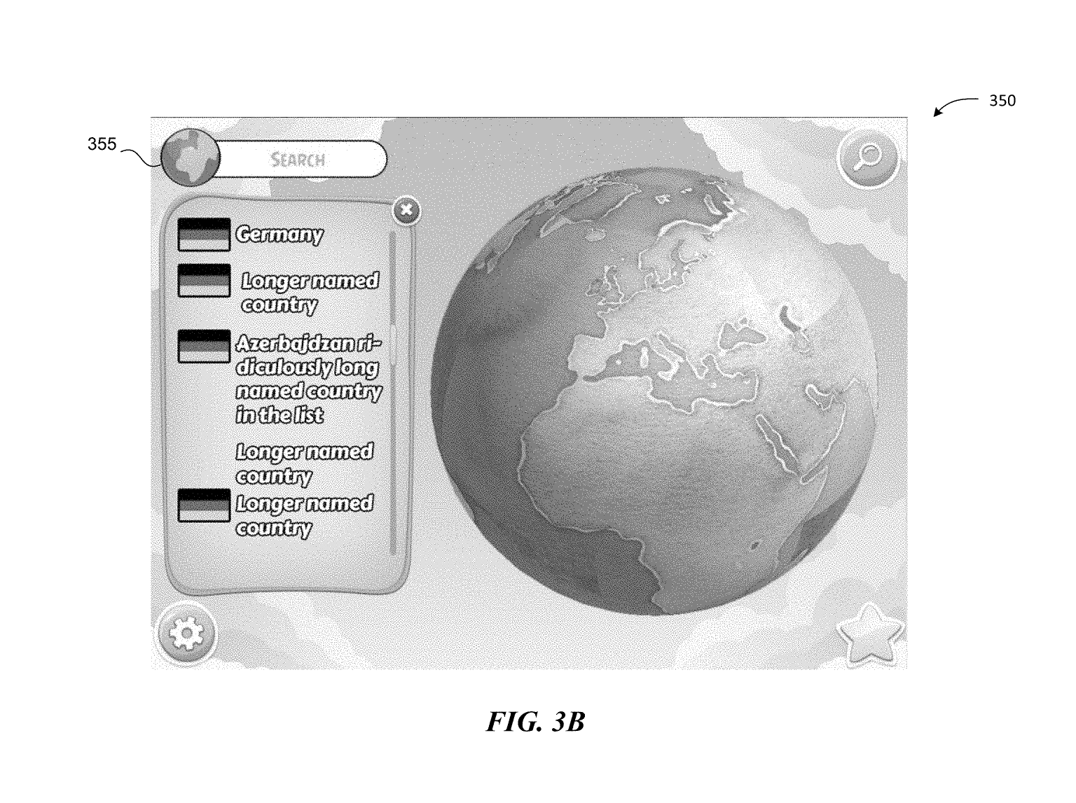

The server 105 enables the user 115, e.g., the big chef 115a or the little chef 115b, to search for the recipes in an interactive way. In one example, the interactive process can include the server 105 generating an image of a vegetable or a fruit in the GUI on the client 110, prompting the little chef 115b to identify the vegetable or fruit, and presenting, upon identification of the vegetable or the fruit, one or more recipes including the vegetable or the fruit. In another example, the server 105 can prompt the user 115 to specify the set of parameters 120, e.g., by inputting text into the game application or selecting them from various parameters presented in the GUI. In yet another example, the server 105 can prompt the user 115 to specify a place like a country or city of user's interest and then present one or more recipes that are popular in the country or the city. Various other interactions may be included to prompt the user 115 to express their interests. In the process of so prompting, the culinary application 145 can stimulate the thought process of the little chef 115b. FIGS. 3-13 illustrate example GUIs using which the user can input the set of parameters 120 and/or interact with the culinary application 145.

After the user 115 specifies the set of parameters 120, the server 105 searches various sources, e.g., the third party systems 150, the storage system 155, for the recipes based on the set of parameters 120. The server 105 retrieves a recipe 125 for the selected dish and transmits the recipe 125 to the client 110. The client 110 displays the recipe 125 in the GUI. In some embodiments, the recipe 125 includes two sets of instructions, e.g., a first set of instructions that includes information regarding activities to be performed by the big chef 115a in preparing the dish of the recipe 125 and a second set of instructions that includes information regarding activities to be performed by the little chef 115b in preparing the dish of the recipe 125. The two sets of instructions can be mutually exclusive, that is, the activities to be performed by the big chef 115a can be different from the activities to be performed by the little chef 115b. So, the culinary application 145 enables the big chef 115a and little chef 115b to engage with each other and have a fun interactive culinary experience.

In some embodiments, the server 105 also generates trivia 130 on one or more topics with the recipe 125. The trivia 130 can include educational information for the little chef 115b and/or the big chef 115a. The trivia 130 can include educative information that is related to the recipe 125. The educative information can be presented in various areas, including math, geography, science and social responsibility. For example, if the recipe 125 includes a particular vegetable such as a carrot, then the server 105 can generate trivia 130 such as “Carrot is good for your eyes.” In another example, if a particular dish selected by the user 115, e.g., sushi, is popular in a particular country, e.g., Japan, then the server 105 can display trivia 130 about that country. The server 105 can retrieve trivia from one or more of the third party systems 150, e.g., Wikipedia, or from the storage system 155. The third party systems 150 can include any servers or systems accessible by the server 105 over a computer network, e.g., Internet, and that allow the server 105 to retrieve the information from them. In some embodiments, the administrator 140 can also upload trivia to the server 105.

The server 105 determines the content of the trivia 130 to be presented based on a target age group of the users. For example, for the big chef 115a, the trivia 130 can be more detailed and more specific, such as “Omega-3 fatty acid is able to stimulate a hormone called leptin, which helps the body's metabolism while regulating the body's weight and food intake.” For a little chef, the same trivia can be presented as “This dish contains an Omega-3 fatty acid which helps in digestion.” Further, the trivia 130 may be presented in a format that is interesting and attractive to the little chef 115b. For example, the trivia 130 can be presented in multimedia format such as text, an image, audio, video, animation, etc. Further, the server 105 can format the trivia 130 based on a target age group of the little chefs. For example, if the target age group is users of 4-6 years, the server 105 can present the trivia 130 using bright colors, animated pictures, videos, simple words, etc., that is attractive to and easily understandable by little chefs of that age.

In some embodiments, the server 105 can facilitate the user 115 to obtain additional information about the trivia 130. For example, the server 105 can include an information link with the trivia 130, using which the user 115 can obtain additional information about the aspect presented in the trivia 130. When the user 115 selects the information link, the server 105 can obtain the additional information from the third party systems 150 and/or the storage system 155 and display the additional information associated with trivia 130.

The trivia 130 can also be math related trivia. For example, the trivia 130 can be like “A gallon is 4 quarts. Each quart is 32 oz.” This may be helpful in teaching the little chef about conversion of units. In some embodiments, the server 105 can also present trivia regarding social causes. For example, the trivia 130 can include information about helping other children who are not fortunate enough to have food on their plate every day. The trivia 130 can include a link for donating the money. When the user 115 selects the link, the user 115 is directed to a GUI within the culinary application 145 and/or a third party system 150 where the user 115 can donate money. The trivia 130 can also provide details about social cause events occurring in the neighborhood. In some embodiments, the server 105 determines the location of the user 115 in various ways, e.g., using data from a global positioning system (GPS) of the client 110, using information based on an Internet Protocol (IP) address of the client 110. After determining the location of the user 115, the server 105 can search the third party systems 150 or the storage system 155 for the social causes in the specified location. The trivia 130 facilitates the user 115 to donate time, e.g., in terms of volunteering, or money to a social cause. This can also help the little chef to become aware of their social responsibilities.

The server 105 can present various types of trivia 130 in various stages in the discovery process of the recipes. For example, some of the trivia 130 can be presented to the user 115 while the user 115 is searching for the recipes, some when the recipe 125 is generated, and some upon completing a particular step of the recipe 125. In some embodiments, the server 105 can present the recipe 125 to the user 115 after the user 115 has viewed at least a portion of the trivia 130. For example, the server 105 can generate portion of trivia 130 as a quiz, and the server can show the recipe 125 to the user 115 or proceed to the next stage in the discovery process only if the user responds to the quiz. In some embodiments, the trivia 130 can include a link for proceeding to a next stage in the discovery process. The user 115 can select the link after reading the trivia 130 and the server 105 can then proceed to the next stage in the discovery process. By having at least a portion of the trivia 130 displayed to the user 115 before generating the recipe 125 the server 105 can ensure that the likelihood of the little chef 115b reading the trivia 130 is higher than when the trivia 130 is presented after the recipe 125 is presented.

By showing the educational information along with interactive searching process, not only the little chef 115b can have fun culinary experience but can also learn about various topics.

In some embodiments, the culinary application 145 can be integrated with a shopping application, e.g., one of the third party systems 150, using which the user 115 can shop online for various products, including ingredients for a particular recipe. For example, the user 115 can specify in the culinary application 145 if certain ingredients of a particular dish the user 115 is requesting the recipe for is unavailable and the server 105 facilitates generating an online order for purchasing those ingredients from the shopping application.

In some embodiments, the culinary application 145 can be integrated with social networking applications, such as Facebook of Menlo Park, Calif.; Twitter of San Francisco, Calif.; Google+ of Google, Mountain View, Calif., etc. The users, e.g., user 115, may share the recipes from the culinary application 145 with other users using the social networking applications. The server 105 also facilitates the user 115 to post pictures, videos, of the dish prepared using the recipe 125 on the social networking applications. The user 115 may also invite other users, e.g., their friends and families, from their social networking applications to use the culinary application 145.

In some embodiments, the culinary application 145 can assign a score, e.g., points, to the user 115, for performing certain activities. For example, the culinary application 145 can provide points for any of the following: creating a user profile with the culinary application 145, answering the questions posted by the culinary application 145 as part of the trivia 130, cooking a meal using the recipe 125, posting an image of the meal cooked using the recipe to a social networking application, posting a recipe to the culinary application 145, buying products or services from the culinary application 145. Different number of loyalty points can be awarded for different types of activities.

Each loyalty point can have an associated financial value. The user 115 may exchange the loyalty points for any of: cash, merchandise, ingredients, membership to the culinary application 145. In some embodiments, the user 115 can use the loyalty points to donate money for a social cause. For example, the user 115 can donate points to various charitable organizations.

FIGS. 2A, 2B and 2C, collectively referred to as FIG. 2, is an example template 200 of a recipe and trivia that can be presented using the culinary application of FIG. 1, consistent with various embodiments. In some embodiments, the recipe and trivia in the example 200 are similar to the recipe 125 and the trivia 130 of FIG. 1. The example template 200 includes a recipe for a dessert “Quince Paste Tart” that is popular in the country “Argentina.” The recipe in the template example 200 includes two sets of instructions. For example, FIG. 2B illustrates a first set of instructions 205 that includes information regarding activities to be performed by the big chef 115a and a second set of instructions 210 that includes information regarding activities to be performed by the little chef 115b. The example template 200 also includes trivia on various topics. For example, the “Fun Fact” trivia in FIG. 2A includes information on the country Argentina, the “Ingredient spotlight” includes information on the ingredients of the dessert, and FIG. 2C illustrates various other trivia that can be presented with the recipe.

In some embodiments, the server 105 can generate templates, such as the example template 200, as and when the server 105 receives content, e.g., recipe and/or the trivia from various sources, e.g., user 115, the administrator 140, third party systems 150. For example, when the administrator 140 inputs a recipe and/or the trivia to the server 105, the server 105 can generate such a template based on the content input by the administrator 140. In some embodiments, the server 105 can have the administrator 140 input the content in the above template. For example, the culinary application 145 can include a content input GUI which can require the administrator 140 to input the content in the above format of the example template 200. Some fields in the content input GUI may be mandatory, which requires an input from the administrator 140, and some fields may not be mandatory. For such non-mandatory fields, the server 105 can search for the information from various third party systems 150 and then add the obtained information to the template. For example, some of the trivia fields, e.g., information regarding where the tools required for preparing the dish are available from purchase, can be non-mandatory and the server 105 can obtain such information from third party systems 150, e.g., crawl the Internet to obtain the information. The server 105 can also obtain recipes from the third party systems 150 and generate templates, e.g., in the format of example template 200, to store the retrieved recipes. The server 105 can store the templates in the storage system 155. In some embodiments, the server 105 uses the templates to present the recipe and the trivia in various GUIs as described below.

While the example template 200 illustrates storing some content, e.g., trivia and ingredient information, with the recipe in a single template, in some embodiments, the server 105 can also store some of the content independent of the recipe. For example, trivia such as information regarding a country, which can be presented with more than one recipe, can be stored separately. Also, since in some embodiments, some of the trivia 130 can be presented to the user 115 before the user 115 selects a dish, the server 105 can store some of the trivia independent of the example template 200.

The following figures and paragraphs describe various GUIs of the culinary application 145 using which the user 115 can discover recipes. In some embodiments, each of the GUIs in FIGS. 3-13 represents a different stage of the recipe discovery process.

FIG. 3A is an example of a first GUI 300 using which a user can specify a country of the dish the user is interested in, consistent with various embodiments. In some embodiments, the first GUI 300 displays a three dimensional (3D) rotating globe with a world map on it. The user 115 can specify a country whose dishes the user 115 is interested in by selecting a particular country from the globe. The first GUI 300 can enable the user to select a country in various other ways. For example, the first GUI 300 can display a list of country names and the user 115 can select one of the countries. In another example, the first GUI 300 can display flags of various countries, and the user 115 can select a country by selecting one of the flags. Further, note that the first GUI 300 can also present other locations, such as cities, states.

FIG. 3B is another example GUI 350 using which a user can specify a country of the dish the user is interested in, consistent with various embodiments. The GUI 350 includes a search bar 355 using which the user 115 can search for a country by the name of the country. In some embodiments, the search bar 355 can be an universal search bar for the culinary application 145 which can be used to search for various content, e.g., recipes, ingredients, across the culinary application 145.

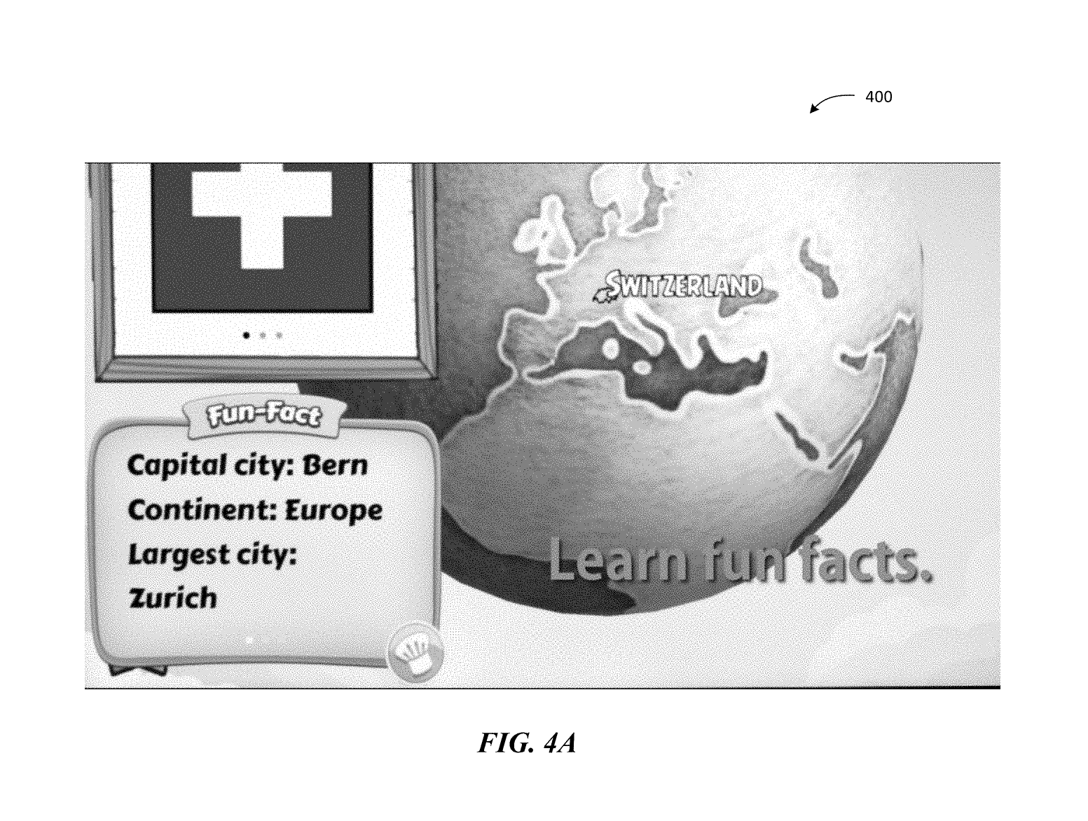

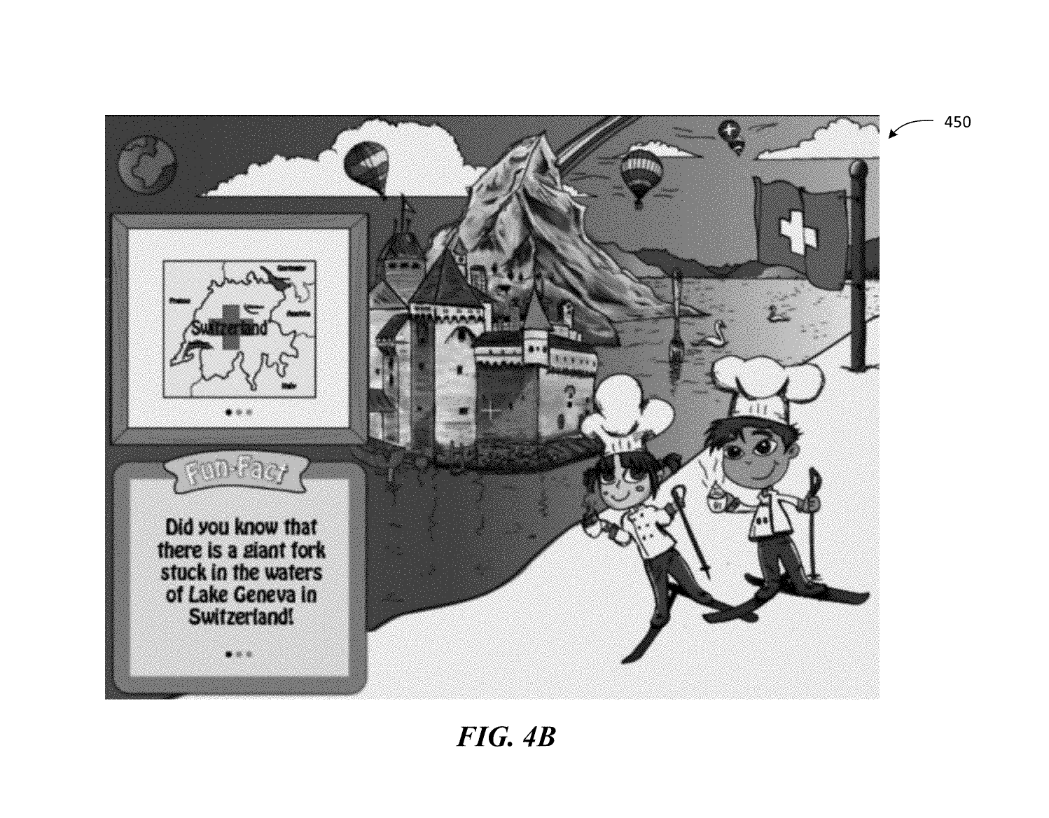

FIGS. 4A and 4B are examples of a second GUI 400 and a third GUI 450 for displaying trivia related to the country selected in the first GUI 300 of FIG. 3, consistent with various embodiments. After the user 115 selects the country in the first GUI 300 the server 105 can generate the second GUI 400 and/or the third GUI 450 for displaying trivia related to the selected country.

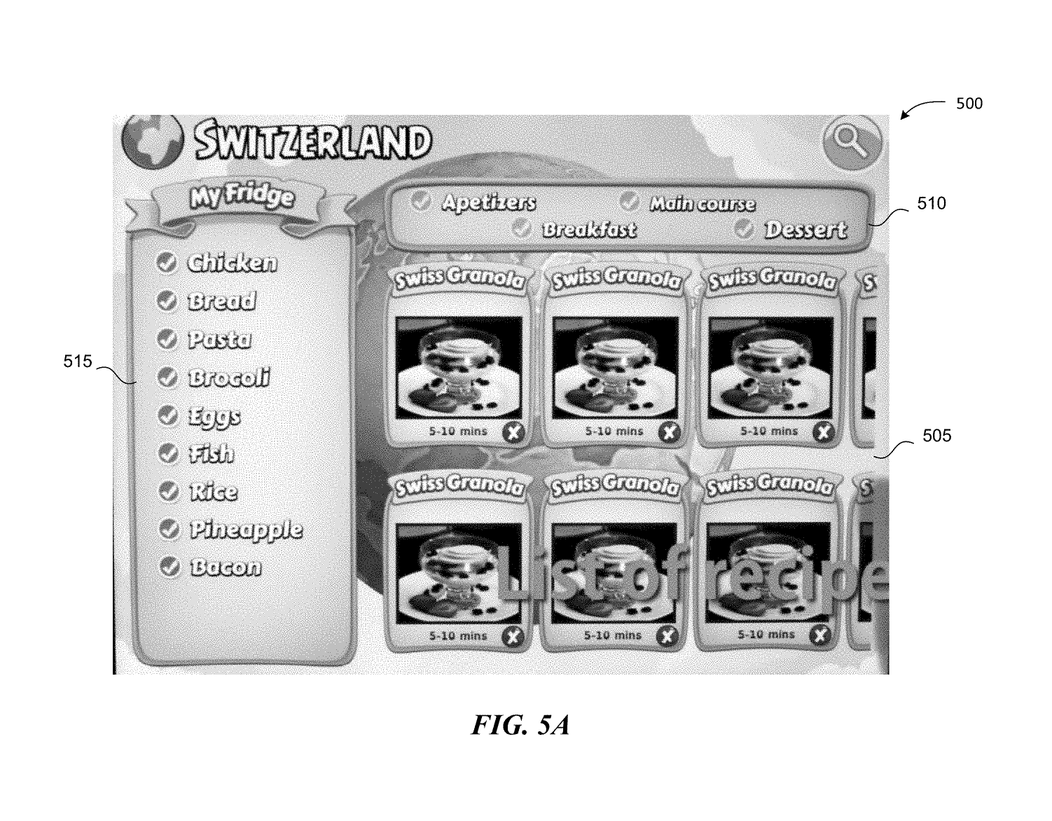

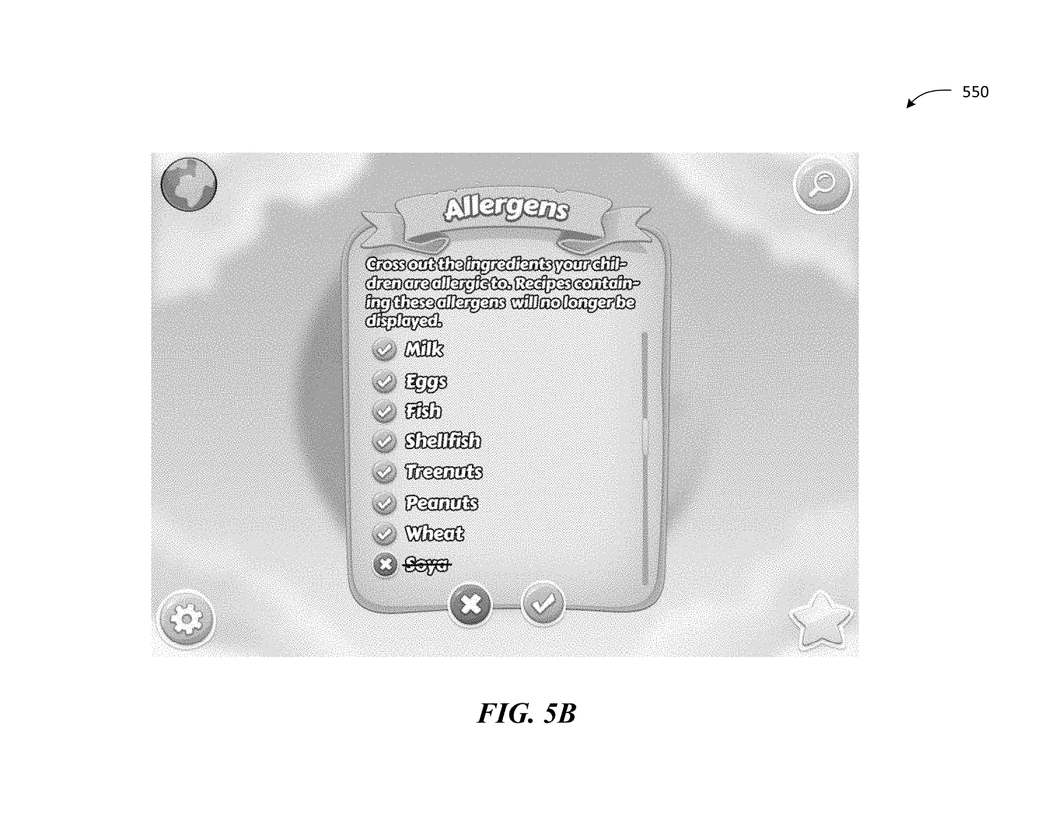

FIG. 5A is an example of a fourth GUI 500 for displaying a list of dishes of the country selected in FIG. 3, consistent with various embodiments. The fourth GUI 500 displays a list of dishes 505 of the country selected in FIG. 3. The user 115 can select one of the dishes from the list of dishes 505. The user 115 can also filter the list of dishes 505 based on the type of the meal, e.g., appetizer, breakfast, main course, the user 115 wants to cook. The user 115 can filter the list of dishes 505 based on the meal type using the tool bar 510. The user 115 can also filter the list of dishes 505 based on user preferred ingredients. The user 115 can specify the preferred ingredients using in the side bar 515. In some embodiments, the user can specify the list of ingredients the user 115 has in his/her fridge in the side bar 515 and the server 105 filters the list of dishes 505 to retrieve only the dishes that can be made using the any of the list of ingredients. The user 115 can then select a particular dish from the list of dishes 505.

FIG. 5B is an example GUI 550 for specifying a list of ingredients, consistent with various embodiments. The user 115 can also specify the ingredients that the user 115 is not interested in, e.g., ingredients the user 115 is allergic to using the GUI 550. In some embodiments, information regarding the ingredients the user 115 is allergic to can be stored as part of the user preferences in the culinary application 145. The server 105 ensures that the dishes including any of the ingredients the user 115 is allergic to is not presented to the user 115.

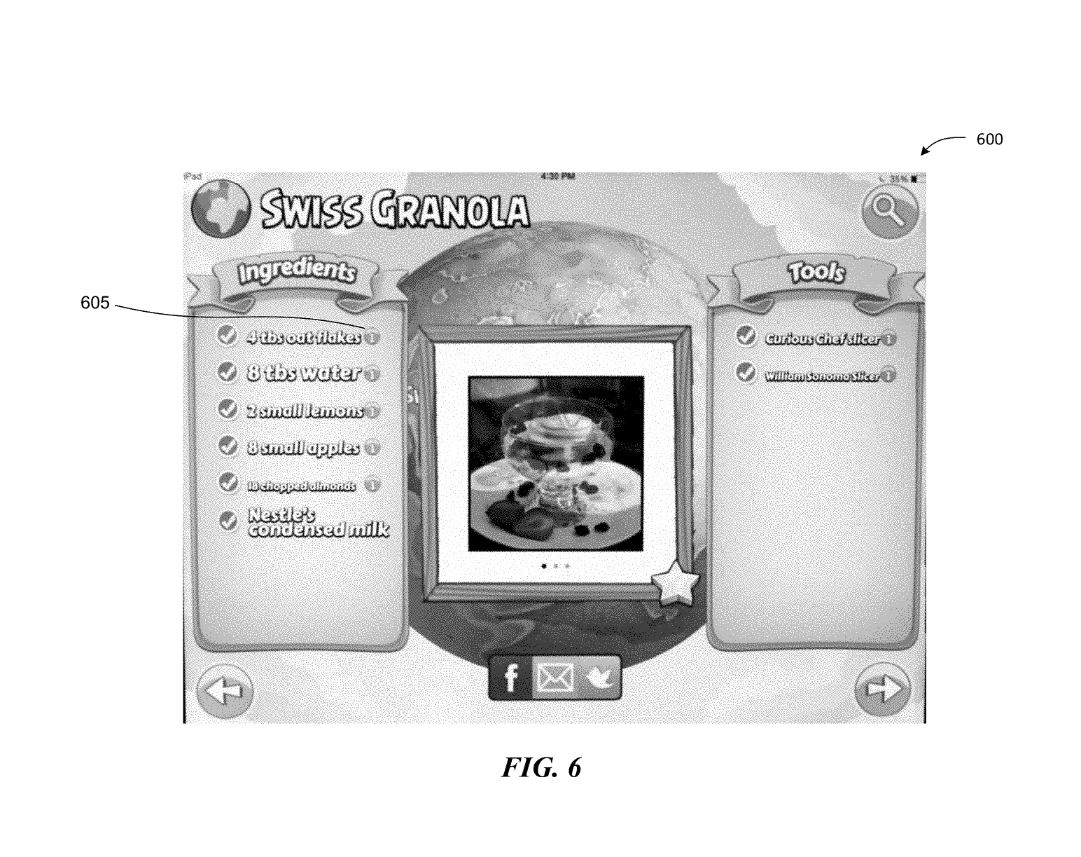

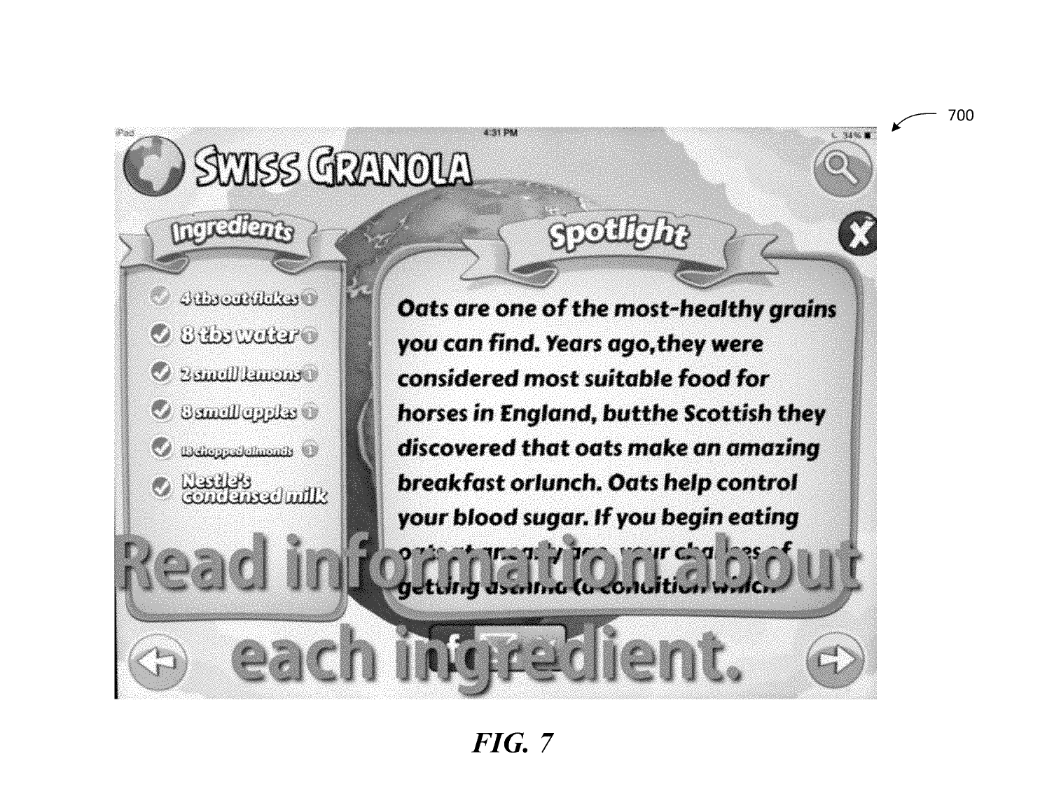

FIG. 6 is an example of a fifth GUI 600 for displaying a user selected dish and ingredients of the dish, consistent with various embodiments. The fifth GUI 600 displays the dish the user 115 selected in the fourth GUI 500 and the ingredients of the dish. The fifth GUI 600 can display an image or a video of the dish. In some embodiments, the fifth GUI 600 can facilitate the user 115 to obtain additional information e.g., trivia 130, about the each of the ingredients of the dish. For example, the fifth GUI can generate a link 605 for an ingredient of the dish. The user 115 can select the link 605 and view the additional information regarding the ingredient, e.g., as illustrated in FIG. 7. FIG. 7 is an example of a sixth GUI 700 for displaying information associated with an ingredient of a dish, consistent with various embodiments. The sixth GUI 700 displays information regarding the oat flakes. In some embodiments, the server 105 can use the templates, e.g., example template 200 of FIG. 2, of a recipe, which contains information regarding the ingredients of the dish, additional information regarding the ingredients, trivia, recipe, etc.

Returning to FIG. 6, the fifth GUI 600 can also display information regarding the necessary tools for preparing the dish. In some embodiments, the fifth GUI 600 can also include a link to a website of a third party system 150, e.g., an online merchant, where the user 115 can purchase the tools from.

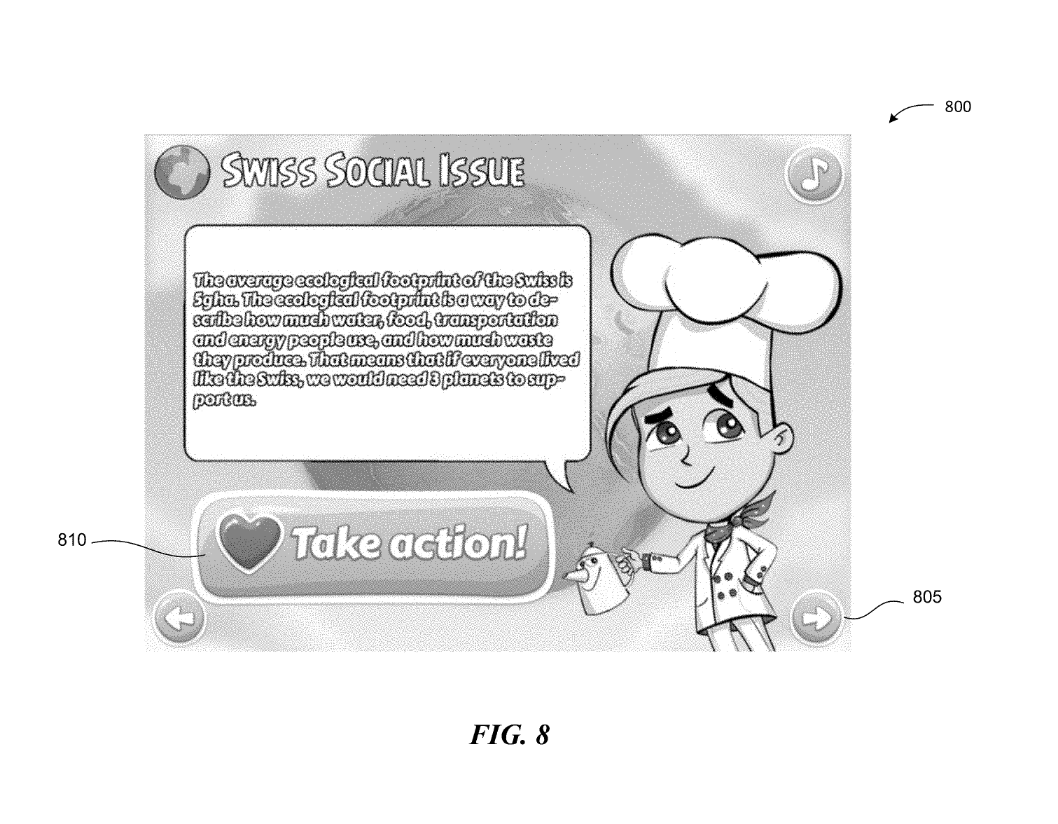

FIG. 8 is an example of a seventh GUI 800 for displaying trivia related to the selected dish, consistent with various embodiments. In some embodiments, the seventh GUI 800 displays information regarding a social issue associated with a country, e.g., the country of the dish the user selected in FIG. 3. In some embodiments, the server 105 can use the templates, e.g., example template 200 of FIG. 2, of a recipe, which contains trivia regarding the country of the dish, social issues in the country, etc., to present the trivia in the seventh GUI 800.

Note that while the server 105 may not show some trivia unless requested by the user 115 (e.g., information about ingredients as shown in FIG. 7, where the user 115 can view them by selecting a link such as link 605), the server 105 may show some trivia, e.g., social issue trivia as displayed in seventh GUI 800, regardless of whether the user has requested. The user 115 may have to indicate to the server 105 that the user has read the trivia, e.g., by selecting a next link 805 or “take action” link 810 to proceed to a next stage in recipe discovery process. In some embodiments, selecting the next link 805 causes the user 115 to proceed to a next stage of the discovery process, e.g., generation of recipe, and selecting the take action link 810 causes the user to proceed to a GUI where the user 115 can contribute, e.g., register for volunteering, to the social issue. By not proceeding to the next stage of the recipe discovery process until the user 115, e.g., little chef 115b, acknowledges the social issue, the culinary application 145 can ensure that the little chef 115b has read about and is aware of the social issue. The user 115 can proceed to the next stage of the recipe discovery process by selecting the next link 805.

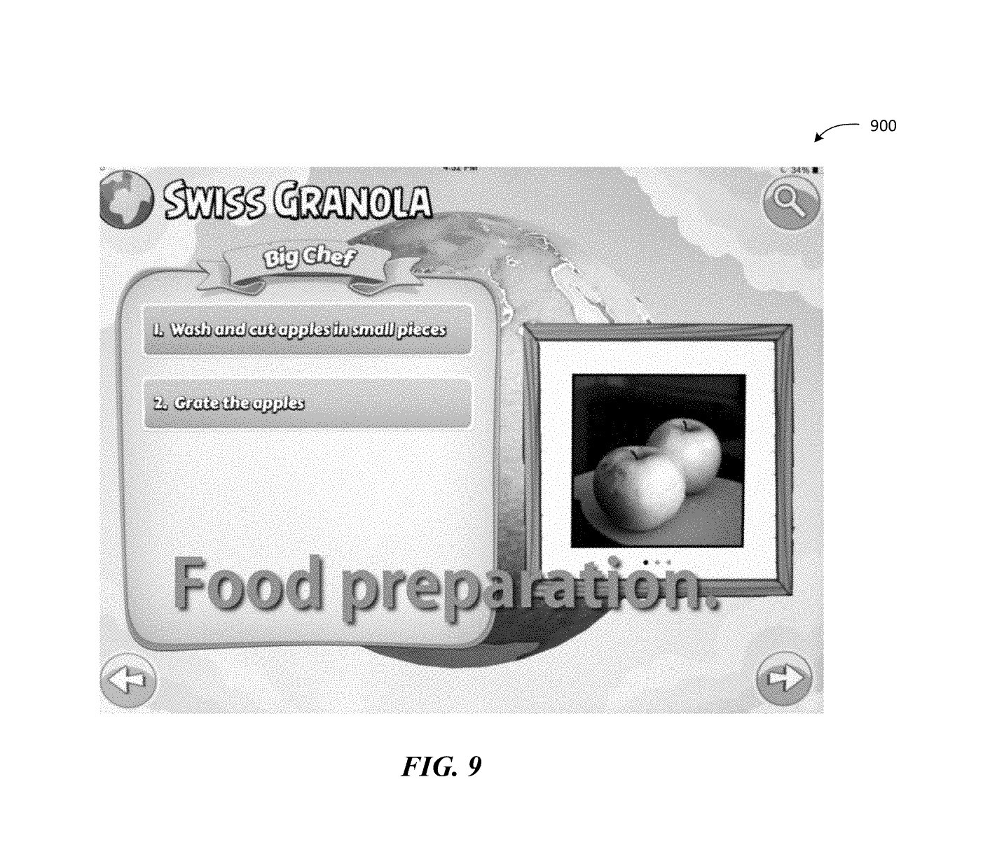

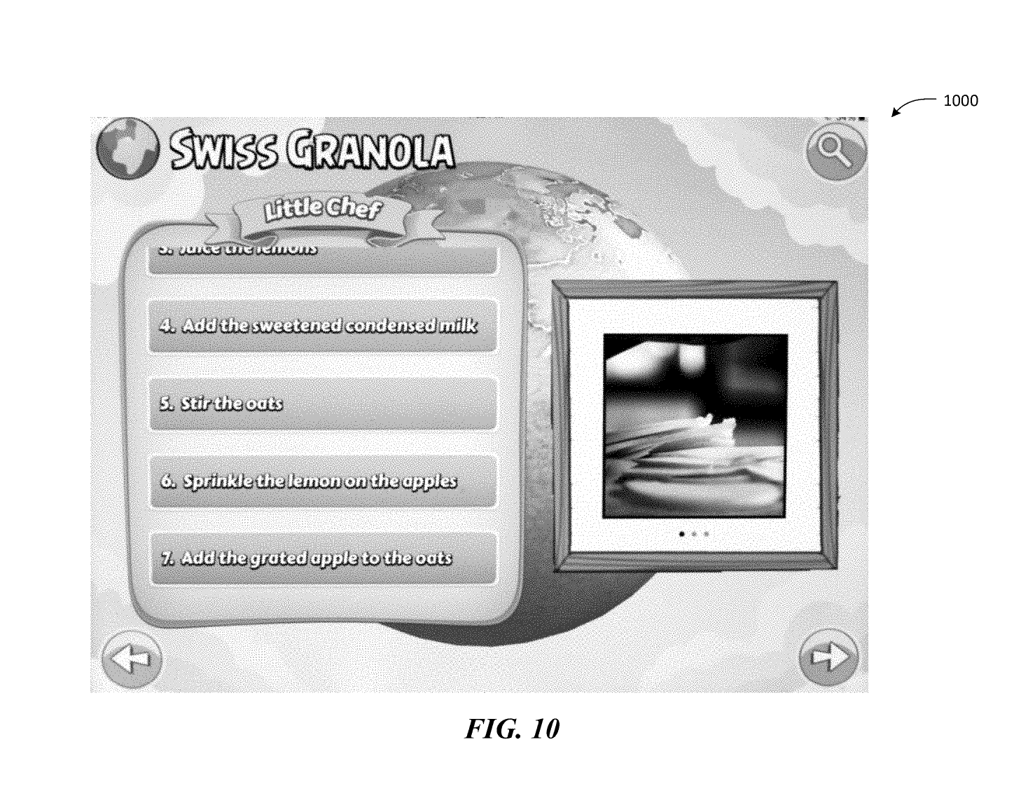

FIGS. 9 and 10 are examples of an eighth GUI 900 and a ninth GUI 1000 for displaying the recipe of a user selected dish, consistent with various embodiments. In some embodiments, the user 115 can select a dish as illustrated in FIG. 5. In some embodiments, the recipe of FIGS. 9 and 10 is similar to the recipe 125 of FIG. 1. The eighth GUI 900 of FIG. 9 displays a first set of instructions of the recipe, which includes information regarding activities to be performed by a big chef 115a. The ninth GUI 1000 of FIG. 10 displays a second set of instructions of the recipe, which includes information regarding activities to be performed by the little chef 115b under the supervision of the big chef 115a. In some embodiments, the first set of instructions and the second set of instructions are mutually exclusive. In some embodiments, the server 105 can use the templates, e.g., example template 200 of FIG. 2, of a recipe, which contains the sets of instructions for both big chef 115a and the little chef 115b for preparing the dish, to present the instructions in the eighth GUI 900 and the ninth GUI 1000.

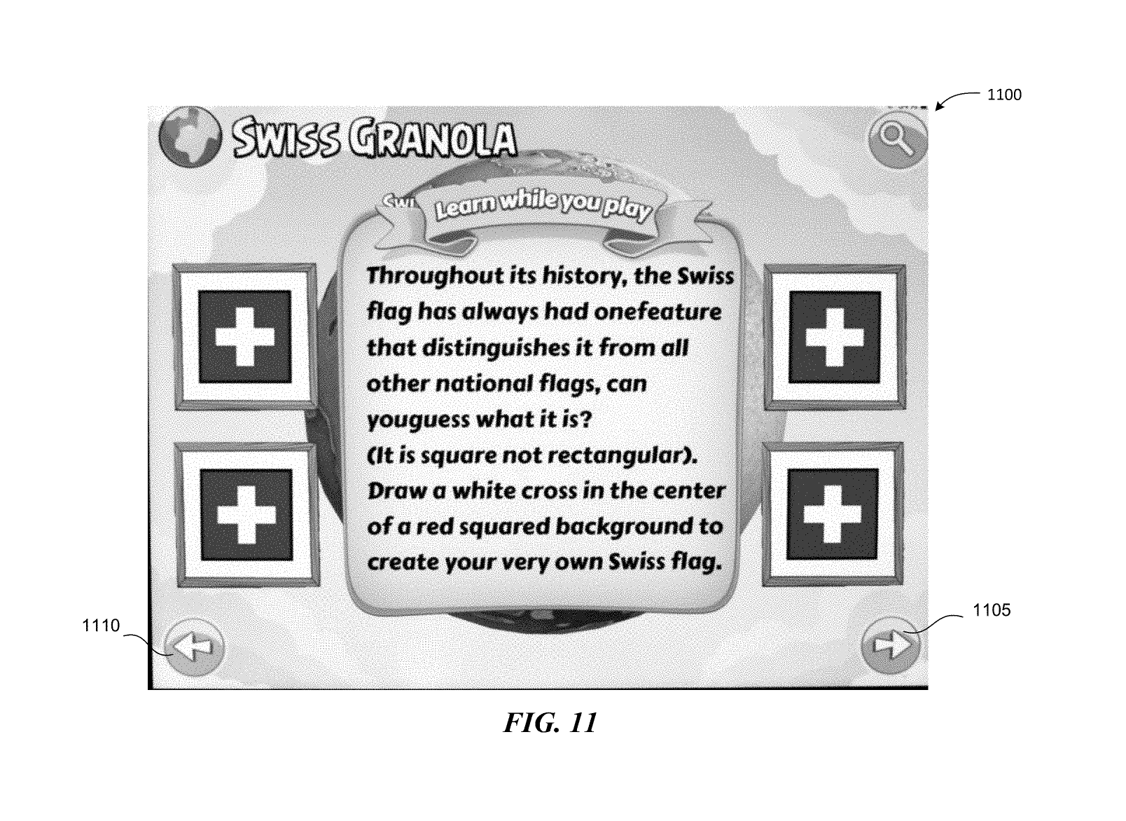

FIG. 11 is an example of a tenth GUI 1100 for displaying trivia related to the recipe of a user selected dish, consistent with various embodiments. In some embodiments, the server 105 can generate some trivia that the user 115 can view while preparing the dish of the recipe. For example, the user 115 can read the trivia when the user 115 has to wait in between the steps of the recipe. The tenth GUI 1100 displays information about the country of the dish. After reading the trivia in the tenth GUI 1100, the user 115 can proceed to the next stage by selecting next link 1105, or go back to previous stage, e.g., ninth GUI 1000, to complete the remaining steps of the recipe by selecting previous link 1110.

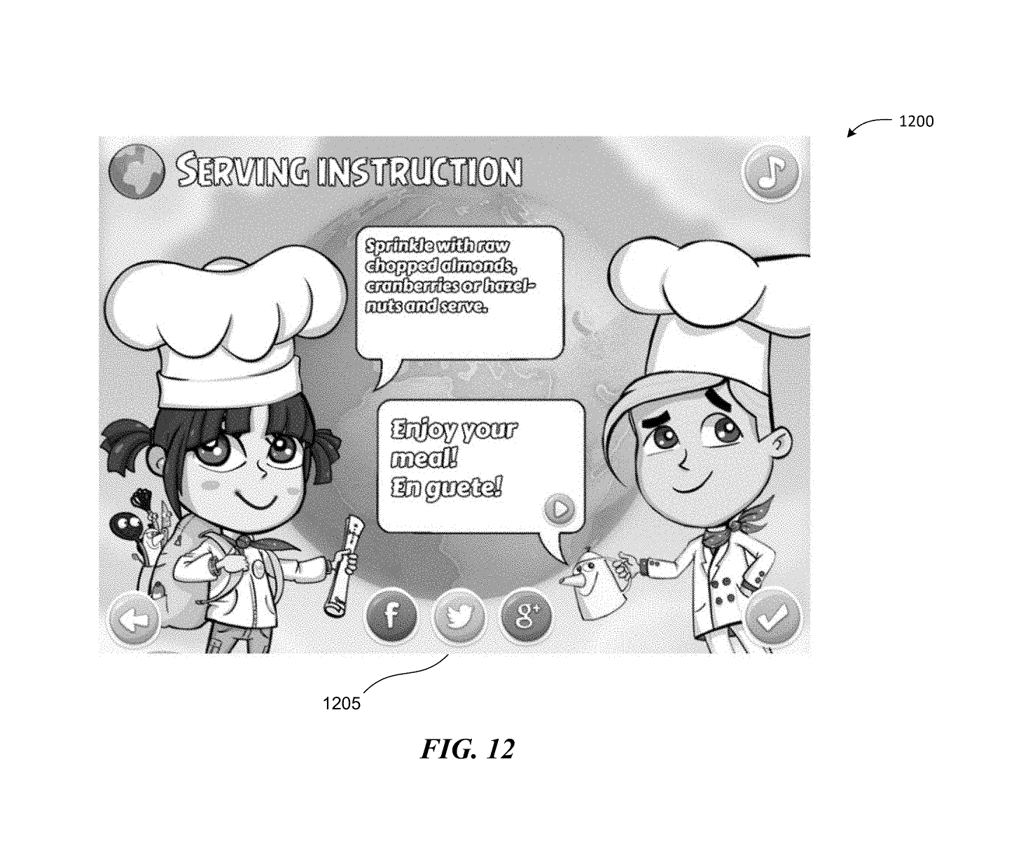

FIG. 12 is an example of a eleventh GUI 1200 for displaying presentation instructions of a dish prepared using the recipe, consistent with various embodiments. The eleventh GUI 1200 can display the presentation instructions of the recipe, which can include instructions for preparing the dish for serving. In some embodiments, the presentation instructions can either be performed by the big chef 115a or the little chef 115b depending on the complexity of the presentation instructions and the age of the little chef 115b.

Note that the sequence of the GUIs illustrated in FIGS. 3-12 is just an example sequence. The server 105 can generate the GUIs in a sequence different from the above illustrated sequence. Further, the order in which the user 115 specifies the parameters for selecting the dish in FIGS. 3-12 is also an example. The server 105 can generate the GUIs in a different sequence, which can require the user 115 to specify the parameters in a different order. For example, instead of specifying the country first and then the ingredients and the type of the meal, the server can generate the GUIs in such a way that the user 115 can specify the type of the meal first, then the ingredients and then the country. The user 115 can share content, e.g., recipe, with other users, e.g., friends of the user 115 in one or more social networking applications, using the links 1205. Further, note that the one or elements in the GUIs, e.g., GUIs of FIGS. 3-12, can be rendered using 3D, virtual reality (VR), and/or augmented reality (AR) techniques. For example, images of at least some ingredients of a recipe can be generated using VR techniques.

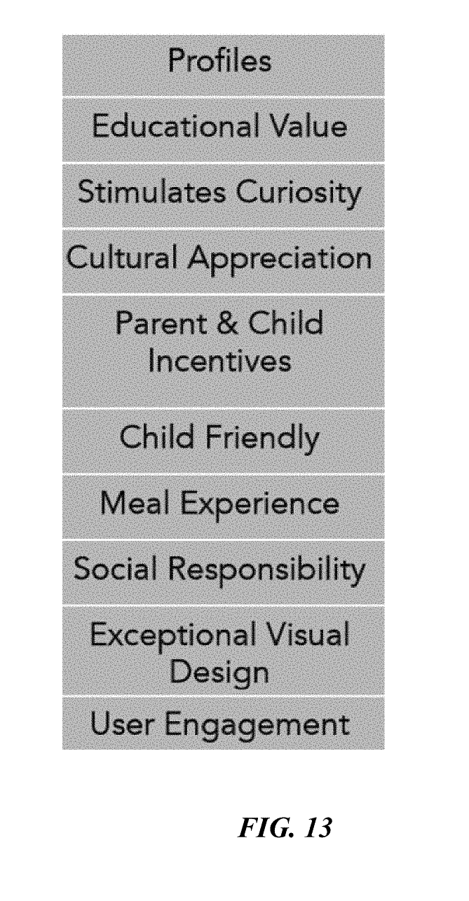

FIG. 13 is an example list of features of the culinary application 145 of FIG. 1, consistent with various embodiments. The culinary application 145 facilitates the user 115 to create user profiles. The user 115 can provide various user preferences as part of the user profile, which the server 105 can use in discovering recipes, presenting trivia, changing the look and feel of the GUI to suit the age-range of the user 115, etc. The culinary application 145 provides educational value to the user 115. For example, the culinary application 145 presents trivia on various topics, including math, science, geography, etc. The culinary application 145 can also facilitate the children to become aware of their social responsibilities.

The culinary application 145 can stimulate curiosity or the thought process of a little chef 115b, e.g., by quizzing the little chef to identify vegetables, fruits, places, etc. The culinary application 145 can also facilitate awareness of various cultures, for example, by presenting trivia related to a particular culture of a country of the selected recipe. The parents and children are provided incentives to engage in cooking a healthy meal. The culinary application 145 will facilitate the family in spending quality time together and also provide the little chef a fun experience of cooking a healthy meal.

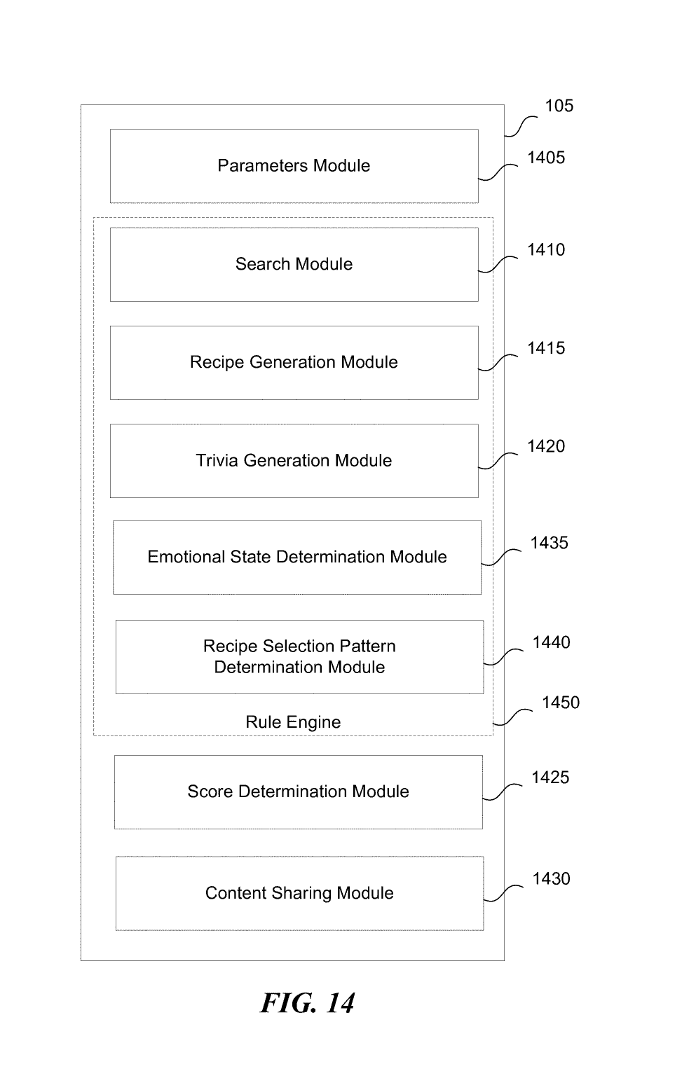

FIG. 14 is a block diagram of the server of FIG. 1, consistent with various embodiments. In some embodiments, the server 105 implements at least a portion of the culinary application 145 using the modules 1405-1430. The server 105 includes a parameters module 1405 that can output a number of parameters to the user 115 based on which the recipes can be discovered, and receive a user selection of one or more of the parameters, e.g., set of parameters 120. The parameters module 1405 outputs the parameters in a GUI, e.g., first GUI 300, at the client 110. In some embodiments, the parameters module 1405 can present the parameters at least as described with reference to the foregoing figures.

The server 105 includes a search module 1410 that can search, e.g., the storage system 155, for dishes that satisfy the user specified parameters and the present a set of dishes to the user 115 in the GUI at the client 110. The search module 1410 can receive a user selection of a dish from the number of dishes for which the recipe, e.g., recipe 125, is to be generated. The search module 1410 can also search for trivia, e.g., trivia 130, that is to be displayed with the recipe generated for the dish. In some embodiments, the search module 1410 can search at the third party systems 150 and/or the storage system 155 for retrieving the recipes and the trivia.

The server 105 includes a recipe generation module 1415 that generates a recipe, e.g., recipe 125, for the user selected dish in the GUI at the client 110. In some embodiments, the recipe generation module 1415 generates the recipe as described at least with reference to FIG. 1 and FIGS. 9, 10 and 12.

The server 105 includes a trivia generation module 1420 that generates a trivia related to the recipe, e.g., trivia 130, in the GUI at the client 110. In some embodiments, the trivia generation module 1420 generates the trivia as described at least with reference to FIG. 1 and FIGS. 4A, 4B, 6-8 and 11. In some embodiments, the recipe generation module 1415 and/or the trivia generation module 1415 can generate recipe templates, e.g., example template 200, to store the recipes and trivia received from various sources, and can use the templates to generate the recipes and trivia in the GUI at to the client 110.

The server 105 includes a score determination module 1425 that can be used to determine a score to be assigned to a user, e.g., user 115, for various activities performed by the user using the culinary application 145. In some embodiments, the score determination module 1425 assigns the score to the user 115 as described at least with reference to FIG. 1.

The server 105 includes a content sharing module 1430 that can receive content from a user, e.g., user 115, of the culinary application 145 to be shared with other users of the culinary application 145 or with users in a social networking application. The content can include an image or a video of a meal prepared by a user using a recipe, e.g., recipe 125, provided by the culinary application 145. The content can include recipes, e.g., for dishes that are not in the culinary application 145. In some embodiments, the trivia generation module 1420 generates the trivia as described at least with reference to FIG. 1.

The server 105 includes an emotional state determination module 1435 that is configured to determine an emotional state of the user 115 based on health meter data associated with the user. In some embodiments, health meter data includes information indicative of the emotional state of the user.

The server 105 includes a recipe selection pattern determination module 1440 that can analyze user behavioral data of the user 115 and determine a recipe selection pattern of the user 115, which can be used in generating recipe recommendations for the user 115.

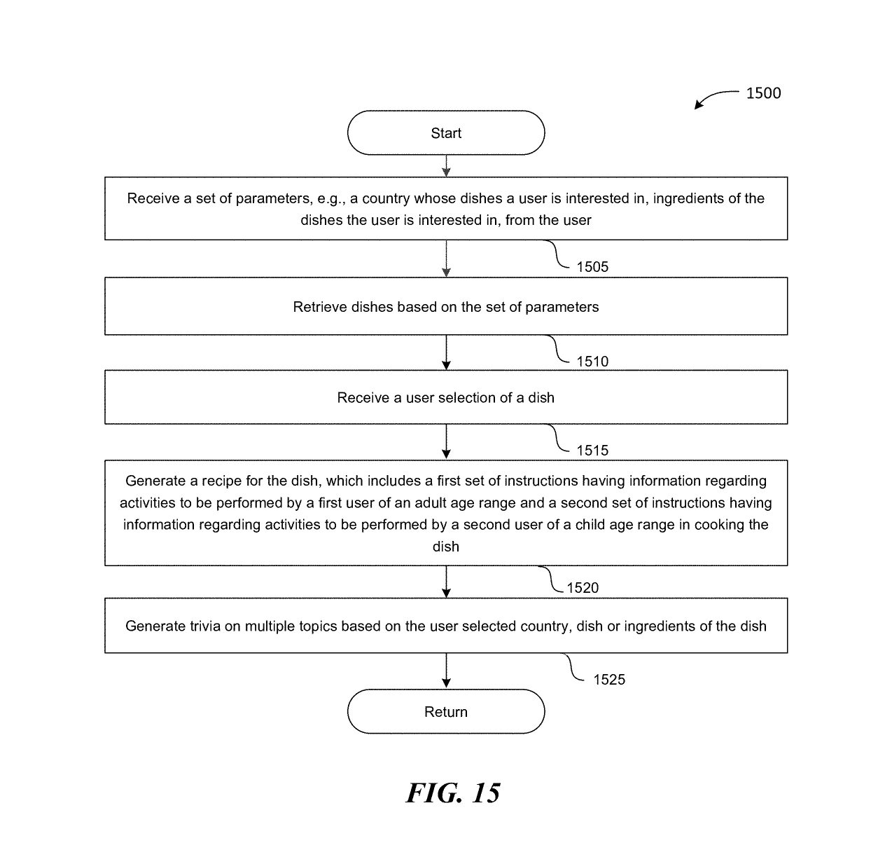

Further, in some embodiments, the search module 1410, the recipe generation module 1415, the trivia generation module 1420, the emotional state determination module 1435, and the recipe selection pattern determination module 1440 can together form a rule engine that is used to generate recipe recommendations and trivia that are customized for a particular user. The rule engine can be implemented using artificial intelligence (AI), machine learning (ML), and/or natural language processing (NLP) techniques. Additional details with respect to the above modules are described at least with reference to FIGS. 15-18 below.

FIG. 15 is a flow diagram of a process 1500 for discovering recipes using a culinary application of FIG. 1, consistent with various embodiments. In some embodiments, the process 1500 can be implemented in the environment 100 of FIG. 1. At block 1505, a parameters module 1405 of server 105, receives a set of parameters from a client, client 110, associated with a user, e.g., user 115, of the culinary application 145 for discovering recipes. In some embodiments, the parameters can be the set of parameters 120 and can include one or more of a country whose dishes the user 115 is interested in, the ingredients preferred by the user, etc. In some embodiments, the parameters module 1405 can receive the parameters as described at least with reference to FIG. 1 and FIGS. 3 and 5.

At block 1510, the search module 1410 can retrieve the dishes based on the parameters, e.g., the set of parameters 120, specified by the user 115 in block 1505. In some embodiments, the server 105 searches the storage system 155 based on the set of parameters and obtains a set of dishes.

At block 1515, the search module 1410 receives a user selection of the dish from the client 110.

At block 1520, the recipe generation module 1415 generates a recipe, e.g., recipe 125, of the user selected dish in a GUI at the client 110. The recipe generation module 1415 generates a first set of instructions that includes information regarding activities to be performed by the big chef 115a and a second set of instructions that includes information regarding activities to be performed by the little chef 115b. In some embodiments, the recipe generation module 1415 generates the first set of instructions as described at least in association with FIG. 9 and the second set of instructions as described at least in association with FIG. 10. In some embodiments, the recipe generation module 1415 generates the recipe 125 by using a corresponding recipe template, such as the example template 200 of FIG. 2, stored in the storage system 155.

At block 1525, the trivia generation module 1420 can generate trivia, e.g., trivia 130, associated with the recipe in the GUI at client 110. For example, the trivia can include information regarding one or more of a country of the dish, social issues in the country, ingredients of the dish, etc. The trivia can be on various topics, including math, science, social, geography, etc. The trivia generation module 1420 can present the trivia in various formats, e.g., in formats that are attractive to children of various age groups. The trivia generation module 1420 can present the trivia at various stages of recipe discovery process 1500, e.g., as described with reference to FIG. 1. In some embodiments, the trivia generation module 1420 can generate the trivia as described at least with reference to FIG. 1 and FIGS. 4A, 4B, 6-8 and 11.

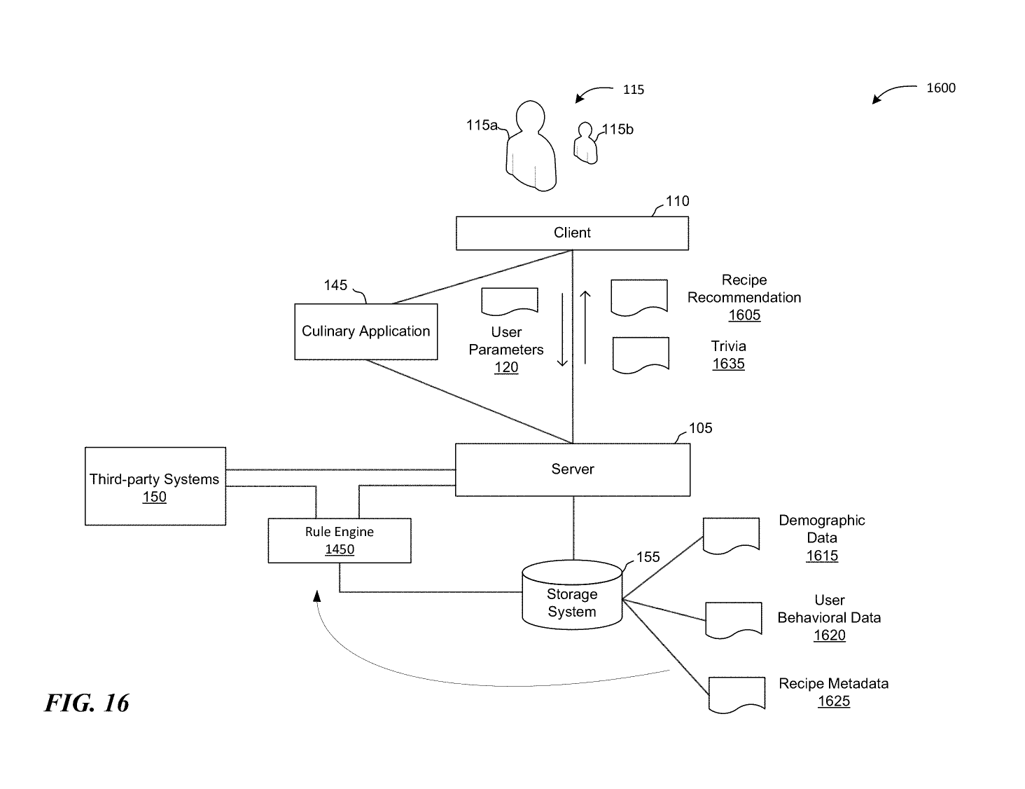

FIG. 16 is a block diagram of an environment 1600 in which the culinary application of FIG. 1 can be implemented consistent with various embodiments. The culinary application 145 generates a recipe recommendation 1605 having one or more recipes determined based on the set of parameters 120. In some embodiments, the set of parameters 120 includes information, such as health meter data, which is indicative of an emotional state of the user 115. The culinary application 145 analyzes the health meter data to determine the emotional state of the user and determines one or more recipes that are known to improve the emotional state. For example, the health meter data can indicate that the user 115 is depressed, and the culinary application 145 can determine one or more recipes that include ingredients that are known to be anti-depressants, such as saffron, and present the recipes in the recipe recommendation 1605. The user 115 can select one or more of the recipes to prepare the corresponding dish. Note that the emotional state of the user 115 is not limited to a mood of the user 115; it can include any of multiple health conditions that is known to improve by consuming the dish prepared based on the corresponding recipe or by even performing the activities of the recipe in preparing the dish. Further, the terms “emotional state” and “health condition” can be used interchangeably.

The culinary application 145 can determine that a particular recipe and/or ingredient improves a particular emotional state using various means. For example, an entity such as the administrator 140 may input information regarding the medical benefits or characteristics of an ingredient and/or a recipe, such as used for improving a particular health condition, in the culinary application 145. The administrator 140 may obtain such information from various sources, e.g., from a nutritionist, medical practitioner or the third party systems 150. In some embodiments, the culinary application 145 can employ a rule engine 1450 that can determine the recipes that improve a particular health condition. The rule engine 1450 can be implemented in the server 105 in which the culinary application 145 is implemented, on a server different from the server 105, or portions of the rule engine 1450 can be distributed across servers. The rule engine 1450 can be implemented using AI, ML, and/or NLP techniques. In some embodiments, the rule engine 1450 can analyze content from various third party systems 150 to determine the ingredients and/or recipes that can be used to improve a particular health condition, such as an emotional state. For example, the rule engine 1450 can analyze content from various web resources having healthcare and/or nutritional information and determine which ingredients and/or recipes are used to improve a particular health condition.

In some embodiments, regardless of whether a particular ingredient or a recipe improves the specified health condition, the activities involved in preparing the dish of the recipe can improve the health condition of the user 115. The culinary application 145 can also track how the making of each recipe made the users feel, or what kind of meals they chose based on their mood. For example, the culinary application 145 can track how the recipe or making of the recipe made the users feel, e.g., by eliciting feedback from the users. The feedback can be input by the users in a format that is readable or interpretable by the culinary application 145, e.g., by the rule engine 1450 of the culinary application 145. For example, each of the users can assign a rank, a rating or a score (simply referred to as a “personal health benefit score”) to a recipe that is indicative of the effectiveness of the recipe in improving a particular health condition for the corresponding user. The culinary application 145 can then use the feedback information to generate, or improve the accuracy in generating recipe recommendations for improving various health conditions. For example, if an aggregate health benefit score of the recipe, which is determined as a function of personal health benefit scores assigned by various users, for improving a particular health condition exceeds a specified threshold, then the culinary application 145 can include the recipe in the recipe recommendation 1605 for the user 115. However, if the aggregate health benefit score of the recipe is below the specified threshold, the culinary application 145 may not include the recipe in the recipe recommendation 1605. In some embodiments, if the recipe recommendation 1605 includes more than one recipe, then the recipes may be sorted based on their aggregate health benefit scores in the recipe recommendation 1605.

In some embodiments, in determining the aggregate health benefit score of a recipe, the culinary application 145 can consider personal health benefit score of the recipes for all users or some users, e.g., users whose user profile matches with that of the user 115. In some embodiments, an entity such as the administrator 140 can specify the criteria based on which two users are considered similar, which is described in further detail below.

In some embodiments, the culinary application 145 may consider only the personal health benefit score of the user 115 to the recipe, regardless of the aggregate health benefit score of the recipe, in determining whether or not to include a particular recipe in the recipe recommendation 1605 for the user 115. For example, if the personal health benefit score of the user 115 for a recipe is below a specified threshold, which indicates that the recipe was not effective in improving the emotional state of the user 115, the culinary application 145 may not include the recipe in the future recipe recommendations for the user 115 even if the aggregate health benefit score of the recipe indicated that the recipe was helpful in improving the emotional state of other users. Similarly, in another example, if the personal health benefit score exceeds a specified threshold, which indicates that the recipe was effective in improving the emotional state of the user 115, the culinary application 145 may include the recipe in the future recipe recommendations for the user 115 even if the aggregate health benefit score indicated that the recipe was not helpful in improving the emotional state of other users.

The culinary application 145 can obtain the health meter data of the user 115, which is used to determine the emotional state of the user 115, in various ways. In some embodiments, the culinary application 145 can ask the user 115 to input the user's emotional state, e.g., by providing a drop down list having various health conditions/emotional states from which the user 115 can select, or by presenting a series of questions which the user 115 can answer. In some embodiments, the culinary application 145 can obtain the health meter data, e.g., vitals of the user 115, such as body temperature, blood pressure, pulse rate, from a wearable device associated with the user 115. The culinary application 145 can then analyze the health meter data to identify and/or determine the emotional state of the user 115. In some embodiments, the culinary application 145 can obtain the health meter data, e.g., an image of a face of the user 115, from a camera associated with the client 110 or any other source. The culinary application 145 can then analyze the image of the face, e.g., using facial recognition techniques, to determine the emotional state of the user 115. In some embodiments, the culinary application 145 can obtain the health meter data from various third party systems 150 that include health related data of the user 115.

In some embodiments, when the culinary application 145 presents the recipe recommendation 1605 for improving a particular emotional state of the user 115, the culinary application 145 can render the GUI in which the recipe recommendation 1605 is presented based on a theme that is also useful in improving the emotional state of the user 115. For example, if the emotional state the user 115 is determined as depressed, the GUI in which the recipe recommendation 1605 is presented can be rendered using colors that are known to be lively and/or energetic, include audio, video, animations or other multimedia components that help in alleviating the depression.

The culinary application 145 can generate recipe recommendation 1605 and trivia 1635 that are customized to a particular user or groups of users. The rule engine 1450 can use adaptive learning techniques to effectively deliver the recipe recommendation 1605 and/or the trivia 1635 in a targeted and personalized manner, including accommodations for users with special needs such as visual, hearing, and speech impairments. The rule engine 1450 makes, adapts, and/or improves the generation of recipe recommendation 1605 for users based on various data, such as demographic data 1615, user behavioral data 1620, and recipe metadata 1625. The above data can be obtained from or derived using the information stored in the storage system 155.

The demographic data 1615 can include age of a user, grade level of the user, ethnicity of the user, languages of preference spoken by the user, user's appreciation of science and math, etc. The user behavioral data 1620 can include user preference data such as recipes selected by the user 115, parameters 120 specified by the user 115 in searches for the recipes, scores assigned by the user to the recipes, topics of interest for trivia, etc. The user behavioral data 1620 can include user engagement data such as a duration for which the user 115 used the culinary application 145, a number of recipes completed by the user 115, an exit rate that is indicative of where in a workflow of the culinary application the user 115 may have exited the culinary application 145, number of quizzes (presented as part of trivia) solved, proficiency in solving a quiz, etc. The recipe metadata 1625 includes data associated with the recipe, such as a name of the chef of the recipe, time taken to prepare the dish of the recipe, a difficulty level of the recipe, health benefit score associated with the recipe, an engagement score or a level of engagement associated with the recipe, which is indicative of how far along the users performed the activities in the recipe before giving up, and a user score of the recipe, which is indicative of how much the user likes or dislikes the recipe, which can be assigned by the user based on various factors, such as whether the user liked the taste of the dish, the user enjoyed preparing the dish, etc.

The rule engine 1450 determines a recipe selection pattern of the user 115 based on one or more of the demographic data 1615, user behavioral data 1620, and recipe metadata 1625, and generates the recipe recommendation 1605 based on the recipe selection pattern. In some embodiments, the recipe selection pattern identifies common characteristics between various recipes selected by the user 115 in the past and determines that the user 115 prefers one or more of those common characteristics with a frequency exceeding a specified threshold. For example, based on the recipes selected by the user 115 in the past, the rule engine 1450 can determine that in searching for the recipes the country chosen by the user 115 as one of the parameters 120 is a tropical country more than a specified threshold number of times, and therefore, the rule engine 1450 can generate the recipe recommendation 1605 including recipes for dishes that are popular in tropical countries. In another example, the recipe selection pattern determines that the user 115 has selected recipes of a specified difficulty level, and therefore, the rule engine 1450 can recommend recipes of the same difficulty level. The difficulty level can be defined based on various attributes, such as time taken to prepare the dish, number of steps or activities to be performed to prepare the dish, number of ingredients required to prepared the dish, cost of the ingredients, ease of availability of the ingredients. The difficulty level can be quantified in various ways, e.g., as “low”, “medium” and “high” in which “low” is the least difficulty level and “high” indicates highest difficulty level and “medium” indicates a difficulty level between “low” and “high.” The difficulty level can be assigned by any entity, e.g., the administrator 140, a cooking expert, a nutritionist, and third party systems 150. In some embodiments, even users who use the recipes can provide feedback regarding the difficulty level of a recipe, and the culinary application 145 can consider the users' feedback to assign or alter the difficulty level of the recipe. In some embodiments, the difficulty level of a recipe can be different for user of different age ranges. For example, a specified recipe can assigned a difficulty level of “low” to users of age range 13-15 years and “medium” or “high” to users of age range 10-12 years.

In another example, the rule engine 1450 can determine one or more recipes for the user 115 based on recipe selection pattern of other users, such as users who are similar to the user 115. Users can register with the culinary application 145 to create a user profile, which can store profile information of the user 115, such as name, age, ethnicity, grade level, dietary preferences, preferences regarding a cuisine, etc. The rule engine 1450 can use the user profile information of the users to determine which users are considered similar. The administrator 140 can specify the criteria based on which two users are considered similar. For example, two users of the same age range are considered similar. In another example, two users of the same age range and same ethnicity are considered similar. In yet another example, two users of the same age range are considered less similar than two users of the same age range and same ethnicity. The recipe selection pattern can consider the level of engagement of the users for various recipes and/or the user scores assigned to the recipes in determining the recipes to be recommended to the user 115. For example, if the level of engagement for a set of recipes by a set of users is below a specified threshold, the culinary application 145 may not recommend the set of recipes to the user 115. The culinary application 145 may recommend those of the recipes whose level of engagement is above the specified threshold. In another example, if the user score assigned to a set of recipes is below a specified threshold, the culinary application 145 may not recommend the set of recipes to the user 115.

As more and more users and/or as more and more a user uses the culinary application 145, the culinary application 145 adapts to the users preferences, e.g., based on the user behavioral data, and generates recipe recommendations having recipes that are more relevant and preferred by the users. The rule engine 1450 can use AI, ML and NLP techniques for generating recipe recommendations.

In some embodiments, the culinary application 145 also presents trivia 1635 (with a particular recipe that is selected from the recipe recommendations 1605) that is customized and personalized for the user 115, e.g., in a way similar to that of generating the recipe recommendations 1605 described above. The rule engine 1450 is an adaptive learning-based rule engine that adapts to user behavior and generates the trivia 1635 that is customized to user 115, e.g., trivia that is determined to be potentially interesting to the user 115 based on the user behavioral data. By generating trivia that is personalized to the user 115, the culinary application 145 promotes strong user engagement with the culinary application, and maximizes the learning gained by the user 115 using the culinary application 145. The culinary application 145 can generate trivia 1635 (particularly lessons, games and/or quizzes) that will be tailored to each user's level of progress, both academically and as it relates to the user's cooking skills (e.g., determined based on the user behavioral data).

In some embodiments, the culinary application 145 can generate the trivia 1635 to be presented with a recipe by aggregating related content from two or more sources. For example, one of the sources for generating the trivia 1635 can be a specified modular curriculum, such as Nutrition Science and Human Geography (“NSG”), which provide nutrition, science and geography related trivia, and the other source or sources can be the culinary application 145 itself or the third party systems 150, which can provide cooking related trivia. For example, for a recipe having chocolate as an ingredient, the cooking related trivia can have information about different types of chocolate and the NSG related content can have other information pertinent to chocolate such as Mexico being a geographic region where chocolate originated, the process of preparing chocolate, information on Cacao seeds from which chocolate is prepared, etc. The culinary application 145 provides means to effectively connect the cooking-related and the NSG-related content to each other. The culinary application 145 can store content from the specified modular curriculum, e.g., the science-related content, as a first dataset and the cooking-related content as a second dataset. The content from the two datasets can be linked using various means. For example, the culinary application 145 provides a mind-mapping tool using which the users associate content from the first dataset with a related content in the second dataset. In some embodiments, a mind map is a graphical way to represent ideas and concepts or a visual representation of hierarchical information that includes a central idea surrounded by connected branches of associated topics. It is a visual thinking tool that helps structuring information, helping to better analyze, comprehend, synthesize, recall and generate new ideas.

After the concepts or content from different datasets are associated with each other, the culinary application 145 can present this aggregated content as the trivia 1635 with a particular related recipe.

The culinary application 145 can also include various other features, which promote user engagement with the culinary application 145. For example, the culinary application can include a progression and reward feature, which serves to enhance users' motivation to complete their learning and cooking tasks. The progression and reward feature can be based on points that the users receive after completing each learning game. Every game will give the child an amount of points which they can spend either on customizing the visuals of an avatar that guides them through the application, or on unlocking additional features of the culinary application 145 such as virtually exploring new countries, e.g., in the first GUI 300, receiving new recipes, or playing new games. In some embodiments, an avatar is a graphical representation of the user 115, the user's alter ego or character in the culinary application 145. The users can also use the points for customizing avatar's speaking voice or virtual outfits, whereby these outfits would be representative of various cultures and countries. The progression and rewards feature can also generate accolade badges for users for completing tasks or groups of tasks, such as “Master Chef of France” for cooking 20 recipes from France or “Master of Science” for responding correctly to 100 science-themed questions.

In another example, the culinary application 145 can include social networking feature for users, which enables interactions between various app users. The social networking feature allows the users to create an optimal learning plan together, compare their performance, e.g., in completing recipes, quizzes, games, etc., against each other, and communicate with one another. Comparing students' performance will indicate how well they are doing within their age group, region, or country. The social networking feature can rank the users to motivate them to perform better, and to speed up their progress.

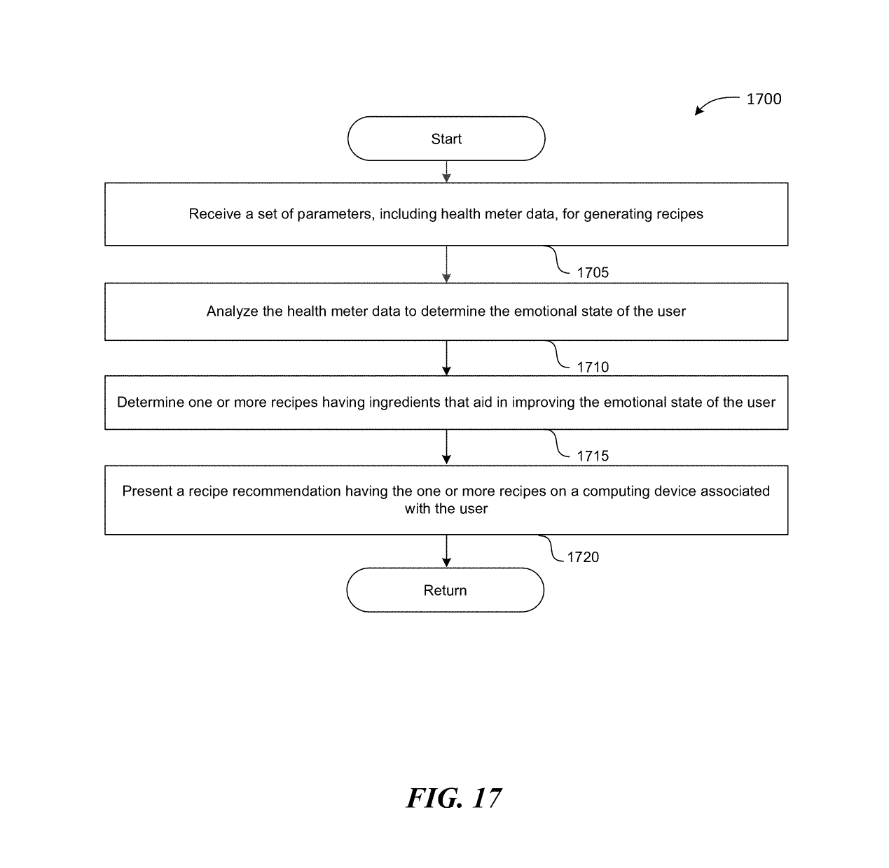

FIG. 17 is a flow diagram for generating a recipe recommendation to improve an emotional state of a user, consistent with various embodiments. In some embodiments, the process 1700 can be implemented in the environment 100 of FIG. 1 or environment 1600 of FIG. 16. At block 1705, the parameters module 1405 receives a set of parameters for generating a recipe recommendation. The set of parameters can include health meter data, which is indicative of an emotional state of the user. The set of parameters can also include other parameters for searching recipes, e.g., the set of parameters 120.

At block 1710, the emotional state determination module 1435 analyzes the health meter data to determine the emotional state of the user, e.g., as described at least with reference to FIG. 16 above.

At block 1715, the recipe generation module 1415 determines one or more recipes for preparing dishes that are known to improve the emotional state of the user, e.g., as described at least with reference to FIG. 16. For example, the recipe generation module 1415 can identify recipes having one or more ingredients that are known to improve the emotional state.

At block 1720, the recipe generation module 1415 generates a recipe recommendation having the one or more recipes, e.g., determined at block 1715, and presents the recipe recommendation to the user at a client associated with the user. For example, the recipe generation module 1415 can generate the recipe recommendation in a GUI, such as the GUI of FIG. 5A.

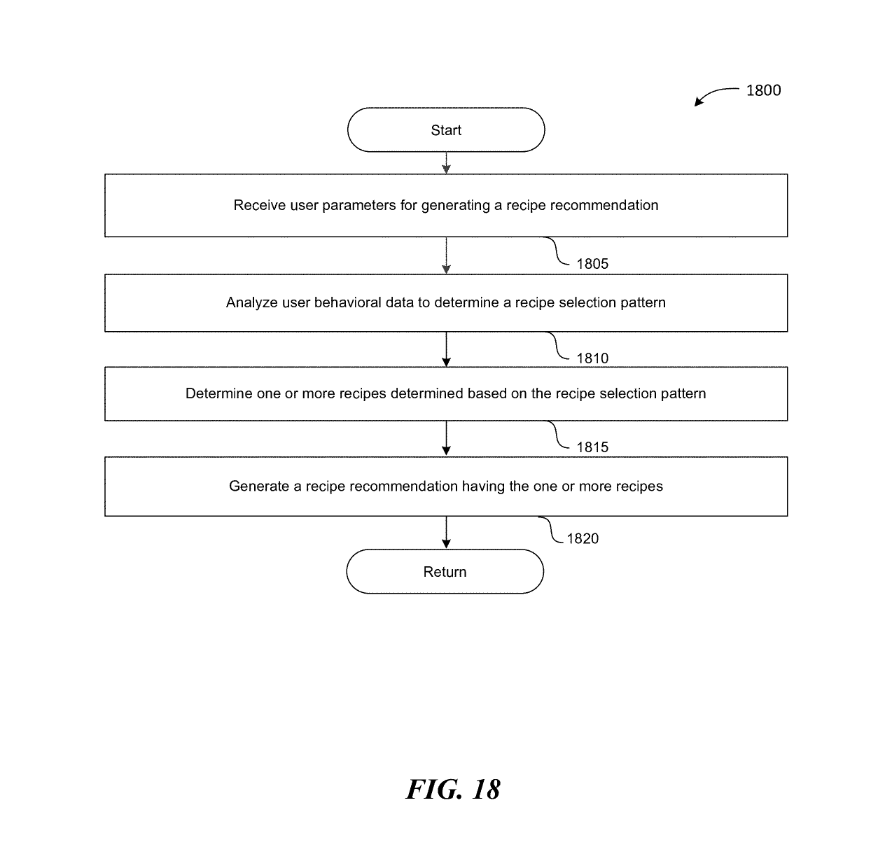

FIG. 18 is a flow diagram for generating a recipe recommendation that is customized for a user, consistent with various embodiments. In some embodiments, the process 1800 can be implemented in the environment 100 of FIG. 1 or environment 1600 of FIG. 16. At block 1805, the parameters module 1405 receives a set of parameters, e.g., parameters 120, from a user for generating a recipe recommendation.

At block 1810, the recipe selection pattern determination module 1440 analyzes user behavioral data of the user to determine the recipe selection pattern of the user. In some embodiments, the recipe selection pattern determination module 1440 determines the recipe selection pattern of the user based on past selections of the recipes made by the user, e.g., as described at least with reference to FIG. 16 above. In some embodiments, the recipe selection pattern determination module 1440 determines the recipe selection pattern based on past selections of the recipes made by other users, e.g., users who are similar to the user, e.g., as described at least with reference to FIG. 16 above.

At block 1815, the recipe generation module 1415 determines one or more recipes based on the recipe selection pattern, e.g., as described at least with reference to FIG. 16 above.

At block 1820, the recipe generation module 1415 generates a recipe recommendation having the one or more recipes, e.g., determined at block 1815, and presents the recipe recommendation to the user at a client associated with the user. For example, the recipe generation module 1415 can generate the recipe recommendation in a GUI, such as the GUI of FIG. 5A.

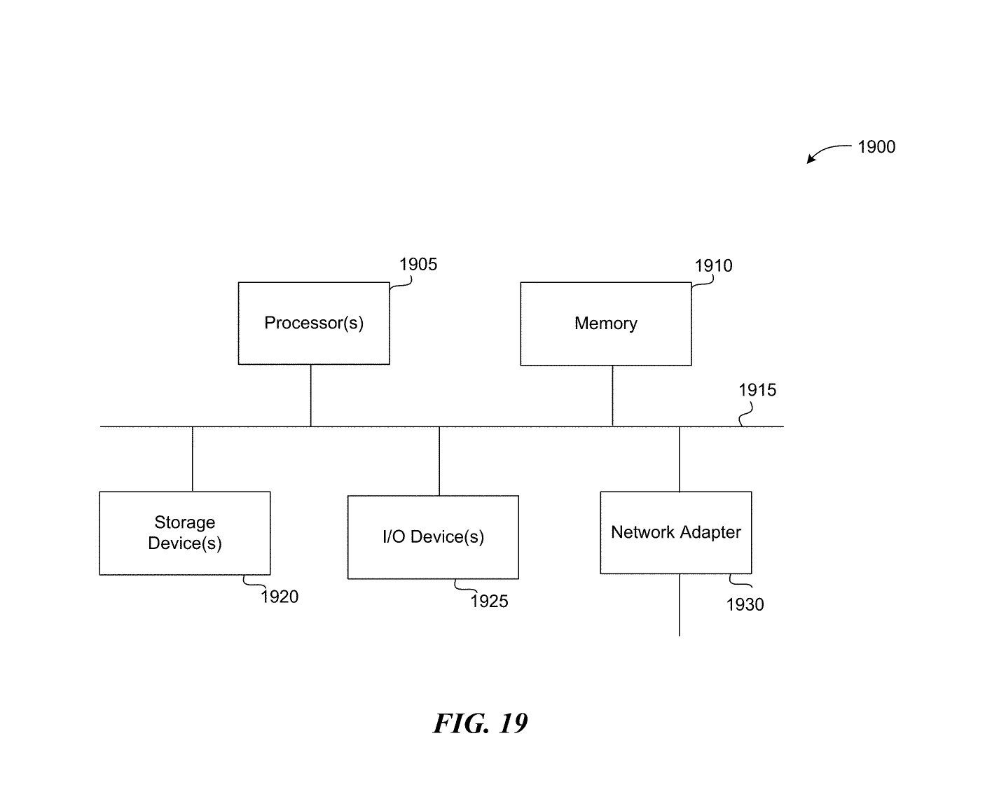

FIG. 19 is a block diagram of a computer system as may be used to implement features of some embodiments of the disclosed technology. The computing system 1900 may be used to implement any of the entities, components or services depicted in the examples of the foregoing figures (and any other components described in this specification). The computing system 1900 may include one or more central processing units (“processors”) 1905, memory 1910, input/output devices 1925 (e.g., keyboard and pointing devices, display devices), storage devices 1920 (e.g., disk drives), and network adapters 1930 (e.g., network interfaces) that are connected to an interconnect 1915. The interconnect 1915 is illustrated as an abstraction that represents any one or more separate physical buses, point to point connections, or both connected by appropriate bridges, adapters, or controllers. The interconnect 1915, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 1910 and storage devices 1920 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 1910 can be implemented as software and/or firmware to program the processor(s) 1905 to carry out actions described above. In some embodiments, such software or firmware may be initially provided to the computing system 1900 by downloading it from a remote system through the computing system 1900 (e.g., via network adapter 1930).

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/We claim:

1. A method performed by a computing system, comprising:
receiving, at the computing system, information regarding an emotional state of a user;
determining, by the computing system and based on the information, a recipe of multiple recipes for a dish that aids in improving the emotional state of the user; and
presenting, by the computing system, the recipe on a computing device associated with the user.

2. The method of claim 1, wherein determining the recipe includes:
determining one or more recipes from the multiple recipes that have an ingredient that is known to improve the emotional state of the user.

3. The method of claim 1, wherein determining the recipe includes:
determining, based on the information, the emotional state of the user as depressed, and
determining one or more recipes from the multiple recipes that have an ingredient that is known to be an anti-depressant.

4. The method of claim 1, wherein determining the recipe includes:
identifying, by the computing system, a set of recipes presented to a set of users associated with the emotional state,
analyzing, by the computing system, feedback data from the set of users for the set of recipes, the feedback data indicative of an effectiveness of dishes prepared using the set of recipes in improving the emotional state of the set of users, and
determining, at the computing system and for presentation to the user, one or more recipes from the set of recipes, the one or more recipes having feedback data indicative of an effectiveness that exceeds a specified threshold.

5. The method of claim 1, wherein determining the recipe includes:
receiving, by the computing system and from a set of users associated with the emotional state, a rating for a set of recipes presented to the set of users, the ratings indicative of an effectiveness of dishes prepared using the set of recipes in improving the emotional state of the set of users,
analyzing, by the computing system, the ratings from the set of users for the set of recipes to generate a score for each recipe of the set of recipes, and
determining, at the computing system and for presentation to the user, one or more recipes from the set of recipes whose score exceeds a specified threshold.

6. The method of claim 1, wherein receiving the information regarding the emotional state includes:
receiving health meter data associated with the user, the health meter data including multiple parameters indicative of at least one of a health condition or the emotional state of the user, and
deriving the emotional state of the user based on the health meter data.

7. The method of claim 6, wherein receiving the health meter data includes receiving a set of parameters indicative of vitals of the user.

8. The method of claim 7, wherein receiving the health meter data includes receiving the health meter data from a wearable device of the user that measures at least a portion of the vitals of the user.

9. The method of claim 6, wherein deriving the emotional state includes:
receiving an image of a face of the user, and
analyzing the image to derive the emotional state of the user.

10. The method of claim 1, wherein receiving the information regarding the emotional state includes obtaining the emotional state as an input from the user.

11. The method of claim 1 further comprising:
receiving a personal health benefit score for the recipe from the user, the personal health benefit score indicative of an effectiveness of the dish in improving the emotional state of the user; and
storing the recipe and the personal health benefit score in association with a user profile of the user in the computing system.

12. The method of claim 1, wherein determining the recipe includes:
retrieving, from a storage system associated with the computing system, a list of recipes presented to the user for improving the emotional state in the past, and
determining, for presentation to the user, one or more recipes from the list of recipes, the one or more recipes having a personal health benefit score exceeding a specified threshold.

13. The method of claim 1, wherein determining the recipe includes:
retrieving, from a storage system associated with the computing system, a history of recipes identified for presentation to one or more users for improving the emotional state, the one or more users having a user profile matching that of the user, and
determining, for presentation to the user, one or more recipes from the history of recipes, the one or more recipes having an aggregate health benefit score exceeding a specified threshold.

14. The method of claim 1 further comprising:
generating trivia on a plurality of topics with the recipe, the trivia related to at least one of a country, the dish, an ingredient of the dish, the recipe, or improving the emotional state of the user.

15. The method of claim 14 further comprising:
generating the recipe and the trivia in a graphical user interface (GUI), the GUI generated based on a theme.

16. The method of claim 15 wherein generating the GUI based on the theme includes generating a plurality of multimedia components of the GUI based on a theme to improve the emotional state.

17. A method performed by a computing system, comprising:
retrieving, by the computing system, information regarding multiple recipes based on a user selection of recipe selection parameters, wherein information includes a list of ingredients, directions to prepare a dish, and trivia on a plurality of topics for each of the multiple recipes;
identifying, in the information regarding a recipe of the recipes, a first set of activities to be performed by a user of a child age range for preparing the dish;
identifying, in the information regarding the recipe, a second set of activities to be performed by a second user of an adult age range for preparing the dish, wherein the second set of activities is different from the first set of activities; and
generating the recipe in a graphical user interface (GUI) with the first set of activities and the second set of activities.

18. The method of claim 17, wherein the recipe selection parameters include one or more of the dish, a country, a cuisine, an ingredient, a preferred health benefit, or an emotional state of the user.

19. A method performed by a computing system, comprising:
receiving, by an application executing at the computing system and from a user, one or more recipe selection parameters for generating a recipe recommendation, the recipe recommendation including multiple recipes for preparing multiple dishes, wherein each of the recipes is associated with a trivia on one or more topics related to the corresponding recipe or the recipe selection parameters;
analyzing, by the computing system, user behavior data to determine a recipe selection pattern, the user behavior data generated based on past selections of one or more recipes by the user; and
generating, by the computing system, the recipe recommendation having the multiple recipes, wherein the multiple recipes are determined based on the recipe selection parameters and the recipe selection pattern.

20. The method of claim 19, wherein analyzing the user behavior data includes:
analyzing the one or more recipe selection parameters selected by the user in the past selections, and
generating the recipe selection pattern, which indicates that the user selected a first recipe selection parameter of the one or more recipe selection parameters with a frequency that exceeds a specified threshold.

21. The method of claim 19, wherein analyzing the user behavior data includes:
determining different parameter values a first recipe selection parameter of the one or more recipe selection parameters that selected by the user for generating different recipe recommendations, and
analyzing the different parameter values to determine the recipe selection pattern, the recipe selection pattern indicating that the different parameter values are related to a specified category.

22. The method of claim 21 further comprising:
generating the recipe recommendation having the recipes that are related to the specified category.

23. The method of claim 21 further comprising:
generating the trivia on a topic related to the specified category.

24. The method of claim 19, wherein analyzing the user behavior data includes:
determining common characteristics between recipes selected by the user in the past, and
analyzing the common characteristics to infer that the user prefers one or more of the common characteristics.

25. The method of claim 24, wherein the common characteristics include a country where the dishes of the recipes are from, a cuisine of the dishes, an ingredient of the dishes, a level of difficulty in preparing the dishes, time required to prepare the dishes, or a type of the dishes.

26. The method of claim 19, wherein analyzing the user behavior data includes analyzing user behavior data of multiple users to determine recipe selection patterns of the multiple users in selecting the recipes.

27. The method of claim 26, wherein generating the recipe recommendation includes determining the multiple recipes based on the recipe selection parameters and recipe selection patterns of one or more users whose user profile matches that of the user.

28. The method of claim 27 further comprising:
presenting, by the computing system and to the user, the trivia presented to the one or more users whose user profile matches that of the user.

29. The method of claim 26, wherein analyzing the user behavior data includes analyzing engagement data of the multiple users, wherein the engagement data indicates a level of engagement of the multiple users with the application or the recipes.

30. The method of claim 29, wherein the level of engagement is determined based on a duration for which a specified user of the multiple users accessed the application.

31. The method of claim 29, wherein analyzing the engagement data includes determining an exit rate of a specified user of the users that is indicative of a stage in the recipe where the specified user exited the application.

32. The method of claim 29, wherein analyzing the engagement data includes determining a number of recipes successfully completed by the user.

33. The method of claim 29, wherein analyzing the engagement data includes determining a number of quizzes in the trivia answered correctly by the user.

34. The method of claim 29 further comprising:
generating the recipe selection pattern based on the analyzing of the engagement data, the recipe selection pattern indicating a level of engagement with a set of the recipes is below a first specified threshold, or above a second specified threshold.

35. The method of claim 34, wherein generating the recipe recommendation includes:
determining the multiple recipes based on the recipe selection pattern, and
ranking the multiple recipes in the recipe recommendation based on the level of engagement of the multiple recipes, wherein a first recipe of the multiple recipes having a level of engagement below the first specified threshold is ranked lower than a second recipe of the multiple recipes having a level of engagement above the second specified threshold.

36. The method of claim 19, wherein analyzing the user behavior data is performed using artificial intelligence or machine learning techniques.

37. A computer-readable storage medium storing computer-readable instructions, the instructions comprising:
instructions for receiving, by an application executing and from a user, one or more recipe selection parameters for generating a recipe recommendation, the recipe recommendation including multiple recipes for preparing multiple dishes;
instructions for analyzing user behavior data to determine a recipe selection pattern, the user behavior data generated based on past selections of one or more recipes by the user; and
instructions for generating the recipe recommendation having the multiple recipes, wherein the multiple recipes are determined based on the recipe selection parameters and the recipe selection pattern.

38. The computer-readable storage medium of claim 37 further comprising:
instructions for receiving a user selection of a specified recipe of the multiple recipes; and
instructions for generating a trivia on a topic related to the specified recipe or the recipe selection parameters.

39. The computer-readable storage medium of claim 38, wherein the instructions for generating the trivia include:
instructions for generating the trivia by selecting content from at least two datasets, wherein the at least two datasets are obtained from different data sources, and wherein at least a portion of the content in the two different data sets are related to each other.

40. The computer-readable storage medium of claim 39, wherein the instructions for generating the trivia by selecting content from the at least two datasets include:
instructions for associating content from a first dataset of the at least two datasets with a related content in a second dataset of the at least two datasets using a mind-mapping function to generate an associated content, and
instructions for presenting the associated content with the specified recipe.

41. The computer-readable storage medium of claim 37, wherein the instructions for generating the trivia include:
instructions for generating the trivia based on a level of progress of the user, wherein the level of progress is determined based on an academic progress data and engagement data associated with the user.

42. A system, comprising:
a processor;
a first module configured to receive information regarding an emotional state of a user;
a second module configured to determine, based on the information, a recipe of multiple recipes for a dish that aids in improving the emotional state of the user; and
a third module configured to present the recipe on a computing device associated with the user, wherein the recipe is presented with trivia having topics related to the recipe.

43. The system of claim 42, wherein the third module is configured to present the recipe and the trivia in a GUI, wherein the third module is further configured to present recipe selection parameters in the GUI using which the user can search for one or more recipes.

44. The system of claim 42, wherein the third module is configured to present one or more of the recipe selection parameters, the recipe or the trivia as a three-dimensional artifact in the GUI.

45. The system of claim 42, wherein the third module is configured to present one or more of the recipe selection parameters, the recipe or the trivia using virtual-reality or augmented-reality techniques.

46. The system of claim 42, wherein the third module is configured to generate an avatar in the GUI representing the user.

47. The system of claim 46, wherein the third module is configured to customize the avatar in the GUI based on one or more of the recipe selection parameters selected by the user.
